(19) United States
(12) Patent Application Publication
(10) Pub. No.: US 2003/0050783 A1
(43) Pub. Date: Mar. 13, 2003

(54) Terminal device, server device and speech recognition method

(76) Inventor: Shinichi Yoshizawa, Osaka (JP)

Correspondence Address: HARNESS, DICKEY & PIERCE, P.L.C., P.O. BOX 828, BLOOMFIELD HILLS, MI, 48303, US

(21) Appl. No.: 10/241,873

(22) Filed: Sep. 12, 2002

(30) Foreign Application Priority Data
Sep. 13, 2001 (JP) 2001-277,853

(51) Int. Cl. G10L 21/00

(52) U.S. Cl. 704/270.1

(57) ABSTRACT

Voice of a user having noises added thereto (noise-added voice) is input by a terminal device and transmitted to a server device. A plurality of acoustic models are stored in advance in a data storage section of the server device. An adapted-model selecting section of the server device selects an acoustic model which is the best adapted to the noise-added voice received by a receiving section from the acoustic models stored in the data storage section. A transmitting section transmits the selected adapted model to the terminal device. A receiving section of the terminal device receives the adapted model from the server device. The received adapted model is stored in a memory. A speech recognition section conducts speech recognition using the adapted model stored in the memory.

### BACKGROUND OF THE INVENTION

1. Field of the Invention

The present invention generally relates to a terminal device, a server device and a speech recognition method. More particularly, the present invention relates to a terminal device, a server device and a speech recognition method for conducting a speech recognition process adapted to individual users and individual environments.

2. Description of the Related Art

Recently, speech recognition technology is increasingly used in mobile phones, portable terminals, car navigation systems, personal computers and the like in order to improve convenience for the users.

The speech recognition technology is used by various users in various environments. In the case of devices such as mobile phones and portable terminals, the type of background noise continuously changes depending on the environment. Similarly, in the case of devices such as stationary terminals for home use, the type of background noise continuously changes due to the sounds on a television and the like. Therefore, various noises are added to a voice produced by the user under such an environment, and acoustic characteristics of speech data to be recognized change continuously. Moreover, even if the same user produces a voice in the same environment, properties of the user's voice change depending on the health condition, aging or the like. Therefore, acoustic characteristics of speech data to be recognized change accordingly. Moreover, acoustic characteristics of speech data to be recognized also changes depending on the type of a microphone attached to a speech recognition system.

Various adaptation technologies are under development in order to implement almost 100% recognition of speech data having different acoustic characteristics.

One example of an adaptation method based on an MLLR (Maximum Likelihood Linear Regression) method is proposed in C. J. Leggetter and P. C. Woodland, “Maximum likelihood linear regression for speaker adaptation of continuous density hidden Markov models”, Computer Speech and Language, 1995, Vol. 9, No. 2, pp. 171-186. In the MLLR method, adaptation is conducted by estimating adapted parameters based on a large amount of voice of a user and modifying acoustic models according to these adapted parameters.

An example of an adaptation method based on speaker clustering is proposed in KATO Tsuneo, KUROIWA Shingo, SHIMIZU Tohru, and HIGUCHI Norio, “Speaker Clustering Using Telephone Speech Database of Large Number of Speakers”, Technical Report of IEICE, SP2000-10, pp. 1-8, 2000. Moreover, an example of an adaptation method using the sufficient statistics and the distance between speakers' characteristics is proposed in YOSHIZAWA Shinichi, BABA Akira, MATSUNAMI Kanako, MERA Yuichiro, YAMADA Miichi and SHIKANO Kiyohiro, “Unsupervised Training Based on the Sufficient HMM Statistics from Selected Speakers”, Technical Report of IEICE, SP2000-89, pp. 83-88, 2000. In the method based on speaker clustering and the method using the sufficient statistics and the distance between speakers' characteristics, adaptation is basically conducted using acoustic models constructed in advance. These acoustic models are constructed using a large amount of speech data of various users in various environments which is obtained in advance. Since speech data close to acoustic characteristics of a user is selected from a database and used to produce an acoustic model, the user need not produce a large amount of voice, which is less burdensome for the user. Moreover, since the acoustic models are constructed in advance, the time required to construct the acoustic models is saved from the adaptation process. Therefore, adaptation can be conducted in a short time.

A method for extending and contracting speech spectra in the frequency axis direction according to a speaker (Vocal Tract Normalization) and the like are also proposed. An example of such a method is proposed in Li Lee and Richard C. Rose, “Speaker normalization using efficient frequency warping procedures”, ICASSP-96, IEEE International Conference on Acoustics, Speech and Signal Processing, pp. 171-186. A speech recognition device for speaker adaptation using spectral transform is disclosed in FIG. 1 of Japanese Laid-Open Publication No. 2000-276188. In this speech recognition device, a detachable adapted-parameter storage means storing adapted parameters of a user of interest is attached to the speech recognition device, and adaptation is conducted using these adapted parameters.

In the MLLR method, acoustic models are adapted using a large amount of speech data of a user. Therefore, the user must read many sentences aloud for adaptation. This is burdensome for the user.

In the method based on speaker clustering and the method using the sufficient statistics and the distance between speakers' characteristics, a large amount of acoustic models must be stored in a speech recognition device in order to deal with speech data for various acoustic characteristics. This requires the speech recognition device to have a huge memory capacity. However, it is difficult to implement such a huge memory capacity in a terminal device having a limited memory capacity such as a mobile phone and a PDA (Personal Digital Assistant).

The method for extending and contracting speech spectra in the frequency axis direction according to the speaker and the technology disclosed in FIG. 1 of Japanese Laid-Open Publication No. 2000-276188 conducts speaker adaptation. However, it is difficult to conduct adaptation to various changes in acoustic characteristics such as a change in property of noises and speaker's voice by using spectral transform. In the technology disclosed in Japanese Laid-Open Publication No. 2000-276188, a huge number of detachable adapted-parameter storage means storing corresponding adapted parameters must be prepared in order to conduct adaptation to many acoustic characteristics such as various noises and properties of voices of various users. Moreover, the user must determine the type of noise and the current property of his/her voice and attach a corresponding adapted-parameter storage means to the speech recognition device.

### SUMMARY OF THE INVENTION

It is an object of the present invention to provide a terminal device enabling reduction in a required memory capacity.

According to one aspect of the present invention, a terminal device includes a transmitting means, a receiving means, a first storage means, and a speech recognition means. The transmitting means transmits a voice produced by a user and environmental noises to a server device. The receiving means receives from the server device an acoustic model adapted to the voice of the user and the environmental noises. The first storage means stores the acoustic model received by the receiving means. The speech recognition means conducts speech recognition using the acoustic model stored in the first storage means.

In the above terminal device, an acoustic model adapted to a voice produced by a user and environmental noises is obtained from the server device and stored in the first storage means. Accordingly, it is not necessary to store acoustic models corresponding to all situations which may be encountered (but actually, are less likely to be encountered) in advance in the first storage means. This enables reduction in required memory capacity.

Preferably, the receiving means further receives an acoustic model which will be used by the user in future from the server device.

Preferably, the above terminal device further includes a determining means. The determining means compares similarity between the voice of the user having the environmental noises added thereto and an acoustic model which has already been stored in the first storage means with a predetermined threshold value. If the similarity is smaller than the predetermined threshold value, the transmitting means transmits the voice of the user and the environmental noises to the server device.

In the above terminal device, speech recognition is conducted using the acoustic model which has already been stored in the first storage means, if the similarity is equal to or higher than the predetermined threshold value. This enables reduction in transmission and reception of data between the terminal device and the server device.

Preferably, if the similarity is smaller than the threshold value, the determining means prompts the user to determine whether an acoustic model is to be obtained or not. If the user determines that an acoustic model is to be obtained, the transmitting means transmits the voice of the user and the environmental noises to the server device.

In the above terminal device, the voice of the user and the environmental noises are transmitted to the server device only when the user determines that an acoustic model is to be obtained. This enables reduction in transmission and reception of data between the terminal device and the server device.

Preferably, the terminal device further includes a second storage means. The second storage means stores a voice produced by a user. If environmental noises are obtained, the transmitting means transmits the environmental noises and the voice of the user stored in the second storage means to the server device.

In the above terminal device, a voice produced by a user when ambient noises hardly exist can be stored in the second storage means. Accordingly, the server device or the terminal device can produce/use a more accurate adapted model. Moreover, in the above terminal device, voices produced by a plurality of people in quiet environments can be stored in the second storage means. Accordingly, an accurate adapted model can be used in the terminal device used by a plurality of people. Moreover, once the voice of the user is stored, the user need no longer produce a voice every time an adapted model is produced. This reduces the burden on the user.

According to another aspect of the present invention, a terminal device includes a transmitting means, a receiving means, a first storage means, a producing means and a speech recognition means. The transmitting means transmits a voice produced by a user and environmental noises to a server device. The receiving means receives from the server device acoustic-model producing data for producing an acoustic model adapted to the voice of the user and the environmental noises. The first storage means stores the acoustic-model producing data received by the receiving means. The producing means produces the acoustic model adapted to the voice of the user and the environmental noises by using the acoustic-model producing data stored in the first storage means. The speech recognition means conducts speech recognition using the acoustic model produced by the producing means.

In the above terminal device, acoustic-model producing data for producing an acoustic model adapted to a voice produced by a user and environmental noises is obtained from the server device and stored in the first storage means. Accordingly, it is not necessary to store acoustic-model producing data for producing acoustic models corresponding to all situations which may be encountered (but actually, are less likely to be encountered) in advance in the first storage means. This enables reduction in required memory capacity.

Preferably, the receiving means further receives acoustic-model producing data which will be used by the user in future from the server device.

Preferably, the terminal device prompts the user to select a desired environment from various environments, and plays back a characteristic sound of the selected environment.

According to still another aspect of the present invention, a server device includes a storage means, a receiving means, a selecting means and a transmitting means. The storage means stores a plurality of acoustic models. Each of the plurality of acoustic models is a model adapted to a corresponding speaker and a corresponding environment. The receiving means receives from a terminal device a voice produced by a user and environmental noises. The selecting means selects from the storage means an acoustic model which is adapted to the voice of the user and the environmental noises received by the receiving means. The transmitting means transmits the acoustic model selected by the selecting means to the terminal device.

The above server device has the storage means storing a plurality of acoustic models. An acoustic model adapted to a voice of a user of the terminal device and environmental noises is selected from the storage means and transmitted to the terminal device. This enables reduction in memory capacity required for the terminal device.

Moreover, acoustic models produced based on a large amount of data close to acoustic characteristics of voice of the user can be stored in the storage means. Therefore, the user need not utter a large amount of sentences in order to produce an acoustic mode, thereby reducing the burden of the user.

Moreover, an acoustic model close to acoustic characteristics of voice of the user can be produced and stored in advance in the storage means. Accordingly, the time to produce an acoustic model is not required, thereby reducing the time required for an adaptation process. As a result, the terminal device can obtain an adapted model in a short time.

Preferably, the selecting means selects an acoustic model which will be used by a user of the terminal device in future from the storage means.

According to yet another aspect of the present invention, a server device includes a storage means, a receiving means, a producing means, and a transmitting means. The storage means stores a plurality of acoustic models. Each of the plurality of acoustic models is a model adapted to a corresponding speaker and a corresponding environment. The receiving means receives from a terminal device a voice produced by a user and environmental noises. The producing means produces an acoustic model adapted to the voice of the user and the environmental noises, based on the voice of the user and the environmental noises received by the receiving means and the plurality of acoustic models stored in the storage means. The transmitting means transmits the acoustic model produced by the producing means to the terminal device.

The above server device has the storage means storing a plurality of acoustic models. An acoustic model adapted to a voice of a user of the terminal device and environmental noises is produced and transmitted to the terminal device. This enables reduction in memory capacity required for the terminal device.

Preferably, the producing means produces an acoustic model which will be used by a user of the terminal device in future.

According to a further aspect of the present invention, a server device includes a storage means, a receiving means, a selecting means and a transmitting means. The storage means stores a plurality of acoustic models. Each of the plurality of acoustic models is a model adapted to a corresponding speaker and a corresponding environment. The receiving means receives from a terminal device a voice produced by a user and environmental noises. The selecting means selects from the storage means acoustic-model producing data for producing an acoustic model which is adapted to the voice of the user and the environmental noises received by the receiving means. The acoustic-model producing data includes at least two acoustic models. The transmitting means transmits the acoustic-model producing data selected by the selecting means to the terminal device.

In the above server device, acoustic-model producing data for producing an acoustic model adapted to a voice of a user of the terminal device and environmental noises is selected from the storage means and transmitted to the terminal device. This enables reduction in memory capacity required for the terminal device.

Preferably, the selecting means selects acoustic-model producing data which will be used by a user of the terminal device in future from the storage means.

Preferably, each of the plurality of acoustic models stored in the storage means is adapted also to a tone of voice of a corresponding speaker.

In the above server device, acoustic models each adapted also to a tone of voice of a corresponding speaker are stored in the storage means. This enables the user of the terminal device to obtain a higher recognition rate.

Preferably, each of the plurality of acoustic models stored in the storage means is adapted also to characteristics of an inputting means for obtaining a voice produced by a speaker in order to produce the acoustic model.

In the above server device, acoustic models each adapted also to characteristics of the inputting means are stored in the storage means. This enables the user of the terminal device to obtain a higher recognition rate.

According to a still further aspect of the present invention, a speech recognition method includes steps (a) to (c). In step (a), a plurality of acoustic models are prepared. Each of the plurality of acoustic models is a model adapted to a corresponding speaker, a corresponding environment, and a corresponding tone of voice. In step (b), an acoustic model adapted to a voice produced by a user and environmental noises is obtained based on the voice of the user, the environmental noises and the plurality of acoustic models. In step (c), speech recognition is conducted using the obtained acoustic model.

In the above speech recognition method, acoustic models each adapted also to a tone of voice of a corresponding speaker are prepared. This enables the user to obtain a higher recognition rate.

Preferably, each of the plurality of acoustic models is adapted also to characteristics of an inputting means for obtaining a voice produced by a speaker in order to produce the acoustic model.

In the above speech recognition method, acoustic models each adapted also to characteristics of the inputting means are prepared. This enables the user to obtain a higher recognition rate.

### BRIEF DESCRIPTION OF THE DRAWINGS

FIG. 1 is a block diagram showing the overall structure of a speech recognition system according to a first embodiment of the present invention;

FIG. 2 is a flowchart illustrating operation of the speech recognition system of FIG. 1;

FIG. 3 shows an example of acoustic models stored in a data storage section in a server of FIG. 1;

FIG. 4 is a block diagram showing the overall structure of a speech recognition system according to a second embodiment of the present invention;

FIG. 5 is a flowchart illustrating operation of the speech recognition system of FIG. 4;

FIG. 6 shows an example of acoustic models and GMMs stored in a memory of a PDA;

FIG. 7 is a block diagram showing the overall structure of a speech recognition system according to a third embodiment of the present invention;

FIG. 8 is a flowchart illustrating operation of the speech recognition system of FIG. 7;

FIG. 9 illustrates a flow of a process of producing an adapted model using an environmental-noise adaptation algorithm;

FIG. 10 is a block diagram showing the overall structure of a speech recognition system according to a fourth embodiment of the present invention;

FIG. 11 is a flowchart illustrating operation of the speech recognition system of FIG. 10;

FIG. 12 shows an example of display on a touch panel;

FIG. 13 is a block diagram showing the structure of a PDA in a speech recognition system according to a fifth embodiment of the present invention;

FIG. 14 is a flowchart illustrating operation of the speech recognition system according to the fifth embodiment of the present invention;

FIG. 15 is a block diagram showing the structure of a mobile phone in a speech recognition system according to a sixth embodiment of the present invention;

FIG. 16 is a flowchart illustrating operation of the speech recognition system according to the sixth embodiment of the present invention;

FIG. 17 is a block diagram showing the overall structure of a speech recognition system according to a seventh embodiment of the present invention; and

FIG. 18 is a flowchart illustrating operation of the speech recognition system of FIG. 17.

### DESCRIPTION OF THE PREFERRED EMBODIMENTS

Hereinafter, embodiments of the present invention will be described in detail with reference to the accompanying drawings. Note that the same or corresponding portions are denoted with the same reference numerals and characters throughout the figures, and detailed description thereof will not be repeated.

(First Embodiment)

### Structure of the Speech Recognition System

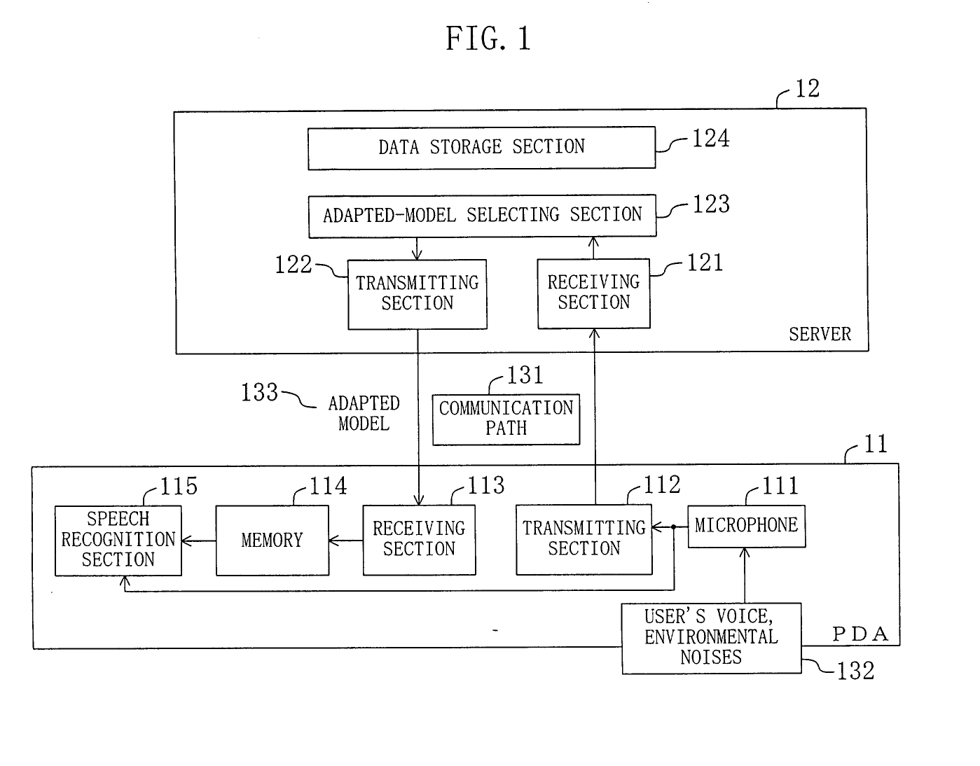

FIG. 1 shows the overall structure of a speech recognition system according to the first embodiment. This speech recognition system includes a PDA (Personal Digital Assistant) 11 and a server 12. The PDA 11 and the server 12 transmit and receive data to and from each other via a communication path 131.

The PDA 11 includes a microphone 111, a transmitting section 112, a receiving section 113, a memory 114 and a speech recognition section 115. The microphone 111 is a data input means for inputting information such as a voice of a user of the PDA 11 and noises around the PDA 11 (environmental noises). The transmitting section 112 transmits data which is input by the microphone 11 to the server 12. The receiving section 113 receives an adapted model transmitted from the server 12. The adapted model received by the receiving section 113 is stored in the memory 114. The speech recognition section 115 conducts speech recognition using the adapted models stored in the memory 114.

The server 12 includes a receiving section 121, a transmitting section 122, an adapted-model selecting section 123, and a data storage section 124. The data storage section 124 stores a plurality of acoustic models and a plurality of selection models in a one-to-one correspondence. Each selection model is a model for selecting a corresponding acoustic model. The receiving section 121 receives data transmitted from the PDA 11. The adapted-model selecting section 123 selects an acoustic model which is adapted to an environment and/or a situation where the PDA 11 is used from the plurality of acoustic models stored in the data storage section 124. The environment herein means noises around the location where the PDA 11 is used, and the like. The situation herein means intended use of an application operated according to the speech recognition process of the speech recognition section 115 of the PDA 11, and the like. The transmitting section 122 transmits the adapted model selected by the adapted-model selecting section 123 to the PDA 11.

### Operation of the Speech Recognition System

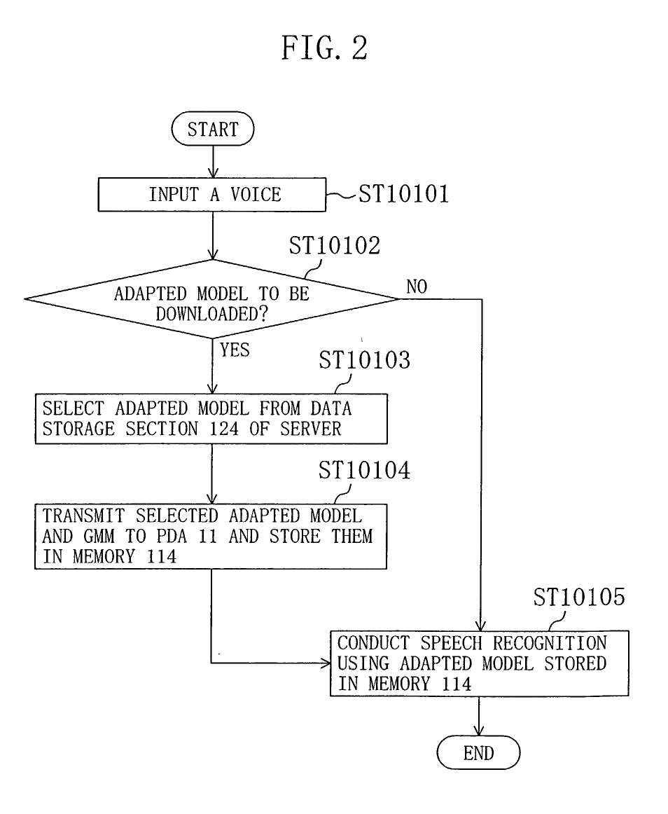

Hereinafter, operation of the speech recognition system having the above structure will be described with reference to FIG. 2. It is herein assumed that the user uses the PDA 11 at an exhibition site.

[Step ST10101]

The user inputs speech data such as “obtain an acoustic model”, “adapt” or “speech recognition” using the microphone 111 mounted to the PDA 11. When the user inputs a voice, noises at the exhibition site are added to this voice. Hereinafter, voice with noises added thereto is sometimes referred to as “noise-added voice”.

[Step ST10102]

The PDA 11 prompts the user to determine whether an acoustic model is to be obtained or not. If the user determines that an acoustic model is to be obtained (yes in step ST10102), the voice obtained in step ST10101, that is, the voice with noises added thereto, is transmitted from the transmitting section 112 of the PDA 11 to the server 12, and the routine proceeds to step ST10103. On the other hand, if the user determines that an acoustic model is not to be obtained (no in step ST10102), no noise-added voice is transmitted to the server 12, and the routine proceeds to step ST10105.

[Step ST10103]

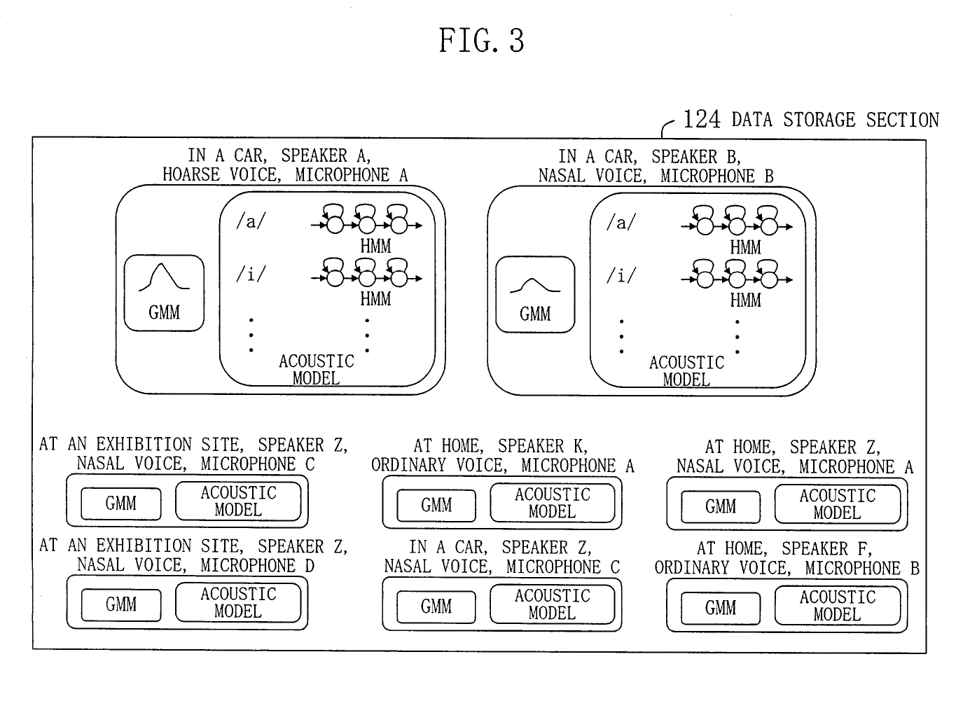

A plurality of acoustic models are stored in advance in the data storage section 124 of the server 12. The plurality of acoustic models are adapted to characteristics of a microphone which was used to obtain speech data produced by speakers in order to produce acoustic models, various speakers in various noise environments, and various tones of voices. FIG. 3 shows an example of acoustic models which are stored in advance in the data storage section 124. In the illustrated example, a plurality of acoustic models (noise-added models) stored in the data storage section 124 are produced based on speech data obtained by speakers such as A, B, C, Z in an ordinary voice, a hoarse voice, a nasal voice and the like using microphones A, B, C, D and the like in noise environments such as in a car, at home and at an exhibition site. Each of the plurality of acoustic models includes a plurality of acoustic models of phonemes (HMMs (hidden Markov models)). The number of acoustic models of phonemes included in each acoustic model and the types of acoustic models of phonemes vary depending on the accuracy of speech recognition (such as context-dependent and context-independent), language (such as Japanese and English), an application and the like. GMMs (Gaussian Mixture Models) are also stored in advance in the data storage section 124 in order to select one of the plurality of acoustic models which is adapted to the environment and/or the situation where the PDA 11 is used as an adapted model. The GMMs are produced based on the speech data used to produce the adapted models without distinguishing the phonemes. The GMMs and the acoustic models are stored in the data storage section 124 in pairs. A GMM is a simple model which represents characteristics of a corresponding acoustic model.

The receiving section 121 of the server 12 receives noise-added voice of the user from the PDA 11. The adapted-model selecting section 123 inputs the noise-added voice received by the receiving section 121 to the GMM corresponding to every acoustic model stored in the data storage section 124. The adapted-model selecting section 123 then selects an acoustic model corresponding to a GMM having the highest likelihood as an adapted model. The selected acoustic model is a model which is the best adapted to ambient noises and the user.

[Step ST10104]

The transmitting section 122 of the server 12 transmits the adapted model 133 selected by the adapted-model selecting section 123 to the PDA 11.

The receiving section 113 of the PDA 11 receives the adapted model 133 from the server 12. The adapted model 133 received by the receiving section 113 is stored in the memory 114. The acoustic model (adapted model) which has been stored in the memory 114 is replaced with this newly downloaded adapted model.

[Step ST10105]

The speech recognition section 115 conducts speech recognition using the adapted model stored in the memory 114. If the user determines in step ST10102 that an acoustic model is to be obtained, speech recognition is conducted using the adapted model downloaded from the server 12 in step ST10103. On the other hand, if the user determines in step ST10102 that an acoustic model is not to be obtained, no adapted model is downloaded, and speech recognition is conducted using the adapted model which has already been stored in the memory 114.

In the speech recognition system of the first embodiment, adaptation is conducted in the server 12 and recognition is conducted in the PDA 11. Since the server 12 has a large storage capacity, adaptation using a complicated model can be conducted. This enables improvement in recognition rate. Moreover, the recognition function can be used in the PDA 11 even if the server 12 is down or the server 12 is subjected to crossing of lines.

It is not necessary to store adapted models corresponding to all situations which may be encountered (but actually, are less likely to be encountered) in the memory 114 of the PDA 11. An adapted model which is suitable for the encountered situation need only be obtained from the server 12 and stored in the memory 114 of the PDA 11. This enables reduction in capacity of the memory 114 of the PDA 11.

Moreover, the user of the PDA 11 conducts speech recognition by using an adapted model which is adapted to noises around the PDA 11, characteristics of the user, tone of a user's voice, and characteristics of the microphone. Accordingly, a high recognition rate can be obtained.

Moreover, acoustic models produced based on a large amount of data close to acoustic characteristics of voice of the user are stored in advance in the data storage section 124 of the server 12. This eliminates the need for the user to produce a large amount of voice to produce an acoustic model.

Moreover, acoustic models produced based on speech data close to acoustic characteristics of voice of the user are stored in advance in the data storage section 124 of the server 12. This saves the time to produce an acoustic model.

Moreover, the previously used adapted model has been stored in the memory 114 of the PDA 11. Therefore, the adapted model can be reused.

### Modification

In the above example, the adapted model which has already been stored in the memory 114 is replaced with the adapted model downloaded from the server 12 (step ST10103). However, the newly downloaded adapted model may alternatively be added to adapted models which have already been stored in the memory 114. In this case, the speech recognition process in step ST10105 is conducted as follows: if the user determines in step ST10102 that an acoustic model is to be obtained, speech recognition is conducted using an adapted model downloaded from the server 12 in step ST10103. If the user determines in step ST10102 that an acoustic model is not to be obtained, no adapted model is downloaded, and an adapted model that is close to the voice that was input in step ST10101 is selected from the adapted models which have already been stored in the memory 114. Speech recognition is conducted using the selected adapted model.

The adapted-model selecting section 123 of the server 12 may select an acoustic model according to the situation where the PDA 11 is used. For example, when an application relating to security (such as an application for processing confidential information by speech recognition, and an application for driving a car by speech recognition) is used, the adapted-model selecting section 123 of the server 12 may select an acoustic model which is more accurately adapted to the situation. In this case, the PDA 11 may transmit information of an active application to the adapted-model selecting section 123 of the server 12 in order to notify the server 12 of the situation where the PDA 11 is used (the level of importance of speech recognition). Alternatively, the PDA 11 may prompt the user to input the level of importance in order to transmit the information (the situation where the PDA 11 is used) to the adapted-model selecting section 123 of the server 12.

The acoustic models of phonemes are not limited to HMMs.

The PDA 11 may transmit an uttered text data such as “obtain an acoustic model” to the server 12. In this case, a specialized GMM can be produced based on voice formed only from phonemes contained in the text, and an adapted model can be selected based on the voice formed only from phonemes. Therefore, an adapted model can be selected with high accuracy. If a GMM is produced from the voice of all phonemes on a speaker-by-speaker basis, characteristics as a speaker that can be represented by the GMM may become ambiguous.

The PDA 11 may transmit a feature vector resulting from transform of voice of the user (such as a cepstrum coefficient) to the server 12.

The GMMs may not be stored in the data storage section 124 of the server 12, and the adapted-model selecting section 123 may select an adapted model using the acoustic models instead of the GMMs. In other words, the adapted-model selecting section 123 may select an acoustic model having the maximum likelihood as an adapted model.

The PDA 11 may conduct speech recognition using the same microphone as that for inputting the information 132 of the PDA 11. In this case, speech recognition can be conducted using an adapted model in view of characteristics of the microphone.

A stationary terminal such as a television, a personal computer and a car navigation system may be used instead of the PDA 11.

The communication path 131 may be a cable (such as a telephone line, an Internet line and a cable television line), a communications network, and a broadcasting network (such as broadcasting satellite (BS)/communications satellite (CS) digital broadcasting and terrestrial digital broadcasting).

The server and the terminal may be disposed close to each other in a three-dimensional space. For example, the server 12 may be a television or a set-top box, and the PDA 11 (terminal) may be a remote controller of the television.

(Second Embodiment)

### Structure of the Speech Recognition System

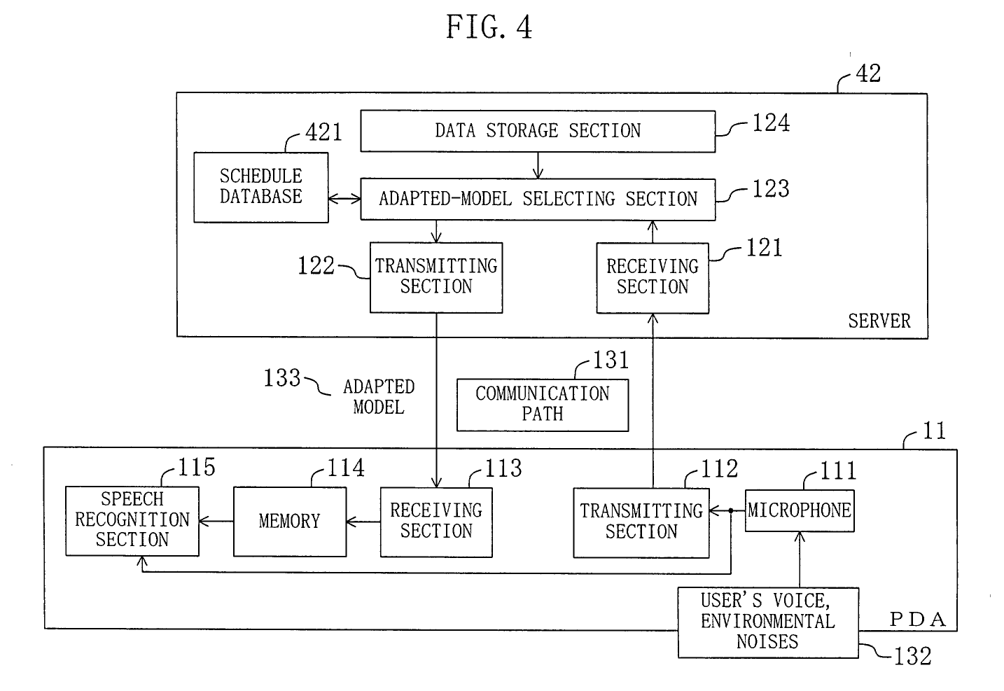

FIG. 4 shows the overall structure of a speech recognition system according to the second embodiment. This speech recognition system includes a PDA 11 and a server 42. The PDA 11 and the server 42 transmit and receive data to and from each other via a communication path 131.

The server 42 includes a receiving section 121, a transmitting section 122, an adapted-model selecting section 123, a data storage section 124, and a schedule database 421. Schedules of the user of the PDA 11 (such as destination, and date and time) are stored in the schedule database 421.

### Operation of the Speech Recognition System

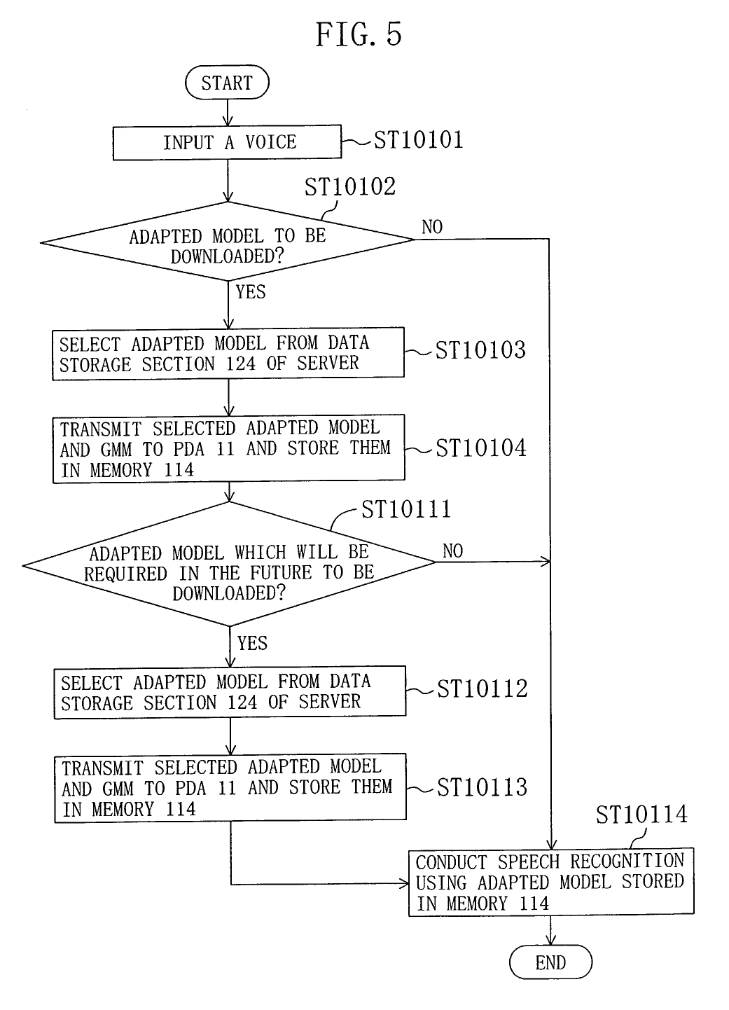

Hereinafter, operation of the speech recognition system having the above structure will be described with reference to FIG. 5. It is herein assumed that a user X uses the PDA 11 at an exhibition site.

The user X downloads both an acoustic model adapted to noises at the exhibition site and an ordinary voice of the user X and GMMs corresponding to these acoustic models to the memory 114 of the PDA 11 in the same manner as that described in the first embodiment (steps ST10101 to ST10104).

[Step ST10111]

The PDA 11 prompts the user X to determine whether an adapted model which will be used in the future is to be obtained or not. If the user X determines that an adapted model which will be used in the future is to be obtained (yes in step ST10111), the transmitting section 112 of the PDA 11 transmits a request signal to the server 42, and the routine proceeds to step ST10112. On the other hand, if the user X determines that an adapted model which will be used in the future is not to be obtained (no in step ST10111), the transmitting section 112 of the PDA 11 does not transmits a request signal, and the routine proceeds to step ST10114. It is herein assumed that the user X determines in step ST10111 that an adapted model which will be used in the future is to be obtained.

[Step ST10112]

The request signal from the PDA 11 is applied to the adapted-model selecting section 123 via the receiving section 121 of the server 42. In response to the request signal, the adapted-model selecting section 123 predicts a situation which may be encountered by the user X in the future, and selects an acoustic model adapted to the predicted situation from the data storage section 124. This selection operation will now be described in more detail. In steps ST10101 to ST10104, an acoustic model adapted to the noises at the exhibition site and the ordinary voice of the user X is downloaded to the memory 114 of the PDA 11 as an adapted model. In view of this, the adapted-model selecting section 123 selects acoustic models such as “acoustic model adapted to noises at an exhibition site and a hoarse voice of the user X having a cold”, “acoustic model adapted to noises at an exhibition site and a voice of the user X talking fast”, “acoustic model adapted to noises at an exhibition site and a voice of the user X talking in whispers” and “acoustic model adapted to noises at an assembly hall which are acoustically close to noises at an exhibition site and an ordinary voice of the user X” as acoustic models adapted to the situation which may be encountered by the user X in the future. Alternatively, the adapted-model selecting section 123 may select an acoustic model with reference to the schedules of the user X stored in the schedule database 421. It is herein assumed that “part-time job at a construction site”, “party at a pub” and “trip to Europe (English-speaking countries and French-speaking countries)” are stored in the schedule database 421 as future schedules of the user X. In this case, the adapted-model selecting section 123 selects acoustic models such as “acoustic model adapted to noises at a construction site and an ordinary voice of the user X”, “acoustic model adapted to noises at a pub and an ordinary voice of the user X”, “acoustic model adapted to noises at an exhibition site and a voice of the user X speaking English” and “acoustic model adapted to noises at an exhibition site and a voice of the user X speaking French” as acoustic models adapted to the situation which may be encountered by the user X in the future.

[Step ST10113]

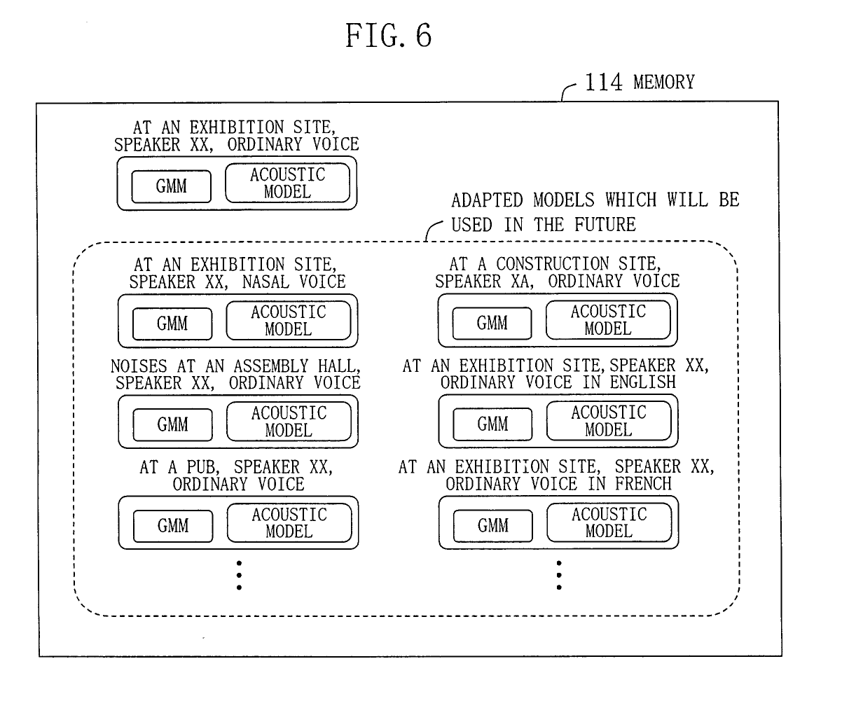

The acoustic models (adapted models) thus selected and GMMs corresponding to the selected models are transmitted from the transmitting section 122 of the server 42 to the PDA 11. The receiving section 113 of the PDA 11 receives the adapted models and the GMMs from the server 42. The adapted models and the GMMs received by the receiving section 113 are stored in the memory 114. In this example, the newly downloaded acoustic models and GMMs are added to the acoustic models and GMMs which have already been stored in the memory 114. FIG. 6 shows an example of the acoustic models and the GMMs thus accumulated in the memory 114.

[Step ST10114]

The speech recognition section 115 conducts speech recognition using an adapted model stored in the memory 114. If the user determines in step ST10102 that an acoustic model is to be obtained, speech recognition is conducted using an adapted model downloaded from the server 42 in step ST10103. If the user determines in step ST10102 that an acoustic model is not to be obtained, speech recognition is conducted using an adapted model which has already been stored in the memory 114.

The user X then uses speech recognition while working at the construction site. The user X inputs voice of the user X at the construction site using the microphone 111 of the PDA 11 (step ST10101). The user X does not request download of an adapted model (step ST10102). The speech recognition section 115 then inputs the voice to each GMM stored in the memory 114 and selects an adapted model corresponding to a GMM having the maximum likelihood with respect to the voice (step ST10111). The speech recognition section 115 conducts speech recognition using the selected adapted model (step ST10114).

A user Y, a co-worker of the user X at the construction site, then uses the PDA 11 at the construction site. The user Y inputs voice of the user Y at the construction site using the microphone 111 of the PDA 11 (step ST10101). The user Y requests download of an adapted model (step ST10102). As a result, an acoustic model adapted to noises at a construction site and an ordinary voice of the user Y (adapted model) and a GMM corresponding to this model are downloaded to the memory 114 of the PDA 11 (steps ST10103 to ST10104). The user Y does not request an adapted model that will be required in the future (step ST10111). The user Y conducts speech recognition by the speech recognition section 115 using the adapted model downloaded to the memory 114 (step ST10114).

The speech recognition system of the second embodiment provides the following effects in addition to the effects obtained by the first embodiment.

A situation which may be encountered is predicted and an adapted model of the predicted situation is stored in advance in the memory 114 of the PDA 11. Therefore, the user of the PDA 11 can use an adapted model without communicating with the server 42. Moreover, adapted models of a plurality of users can be stored in the memory 114 of the PDA 11. Therefore, a plurality of users of the PDA 11 can use an adapted model without communicating with the server 42.

### Modification

In the above example, an adapted model which will be used in the future is obtained according to the determination of the user of the PDA 11. However, such an adapted model may be automatically obtained by the adapted-model selecting section 123 of the server 42. For example, such an adapted model may be obtained in the following manner with reference to the schedules of the user stored in the schedule database 421. It is now assumed that “from 10 a.m., part-time job at the construction site” is stored in the schedule database 421 as a schedule of the user X of the PDA 11. In this case, the adapted-model selecting section 123 selects an “acoustic model adapted to noises at a construction site and an ordinary voice of the user X” from the data storage section 124 at a predetermined time before 10 a.m., e.g., at 9:50 a.m. The selected model is transmitted from the transmitting section 122 to the PDA 111 and stored in the memory 114. Accordingly, at 10 a.m. (the time the user X starts working), speech recognition can be conducted by the PDA 111 using the “acoustic model adapted to noises at a construction site and an ordinary voice of the user X”. If the PDA 11 has a GPS (Global Positioning System) function, the adapted-model selecting section 123 may select an “acoustic model adapted to noises at a construction site and an ordinary voice of the user X” from the data storage section 124 as soon as the user X carrying the PDA 11 comes somewhat close to the construction site.

In the above example, the schedule database 421 is provided within the server 42. However, the schedule database 421 may alternatively be provided within the PDA 11.

Moreover, in the above example, both an adapted model selected by the adapted-model selecting section 123 and a GMM corresponding to the selected adapted model are downloaded to the PDA 11. However, such a GMM may not be downloaded to the PDA 11. In this case, the selected adapted model itself may be used to select an adapted model from the memory 114 of the PDA 11.

The user name may be input together with the voice in step ST10101 and the user name may be matched with the downloaded adapted model. In this case, an adapted model can be selected in step ST10114 by inputting the user name.

The server and the terminal may be disposed close to each other in a three-dimensional space. For example, the server 12 may be a television or a set-top box, and the PDA 11 (terminal) may be a remote controller of the television.

(Third Embodiment)

### Structure of the Speech Recognition System

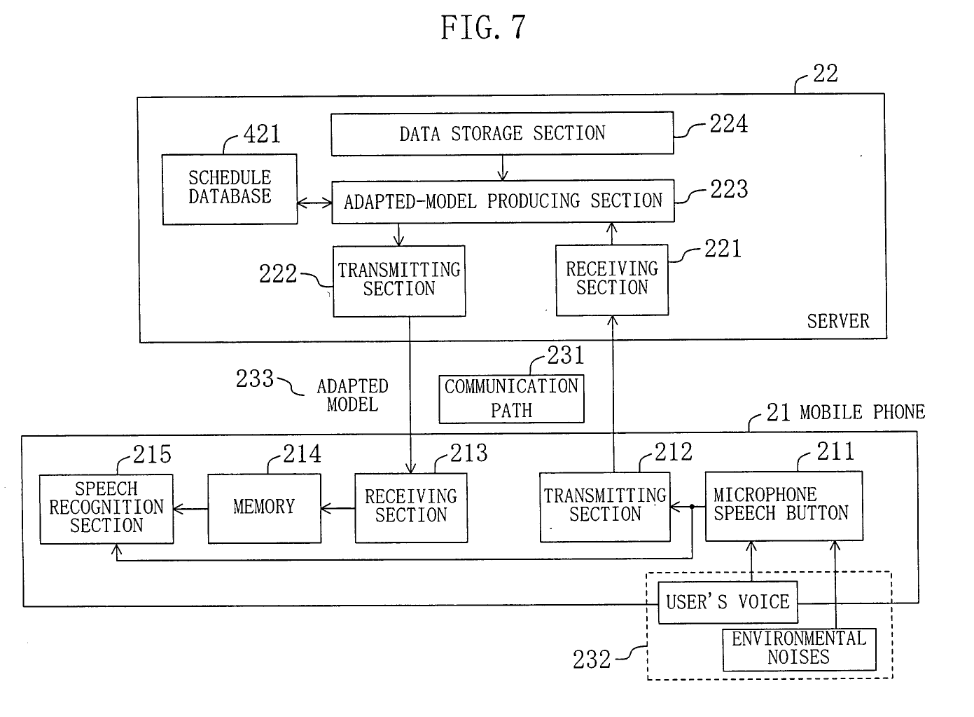

FIG. 7 shows the overall structure of a speech recognition system according to the third embodiment. This speech recognition system includes a mobile phone 21 and a server 22. The mobile phone 21 and the server 22 transmit and receive data to and from each other via a communication path 231.

The mobile phone 21 includes a data input section 211, a transmitting section 212, a receiving section 213, a memory 214 and a speech recognition section 215. The data input section 211 inputs information such as a voice of a user of the mobile phone 21 and noises around the mobile phone 21. The data input section 211 includes a speech trigger button and a microphone. The speech trigger button is provided in order to input the user's voice and the environmental noises independently of each other. The microphone inputs the voice of the user of the mobile phone 21, the noises around the mobile phone 21, and the like. The transmitting section 212 transmits the data which is input by the data input section 211 to the server 22. The receiving section 213 receives an adapted model transmitted from the server 22. The adapted model received by the receiving section 213 is stored in the memory 214. The speech recognition section 215 conducts speech recognition using the adapted model stored in the memory 214.

The server 22 includes a receiving section 221, a transmitting section 222, an adapted-model producing section 223, a data storage section 224, and a schedule database 421. Data for producing an adapted model (hereinafter, referred to as adapted-model producing data) is stored in the data storage section 224. The adapted-model producing data includes a plurality of acoustic models, GMMs corresponding to the plurality of acoustic models, and speech data of a plurality of speakers. The receiving section 221 receives the data transmitted from the mobile phone 21. The adapted-model producing section 223 produces an adapted model based on the data received by the receiving section 221 and the data stored in the data storage section 224. The transmitting section 222 transmits the adapted model produced by the adapted-model producing section 223 to the mobile phone 21.

### Operation of the Speech Recognition System

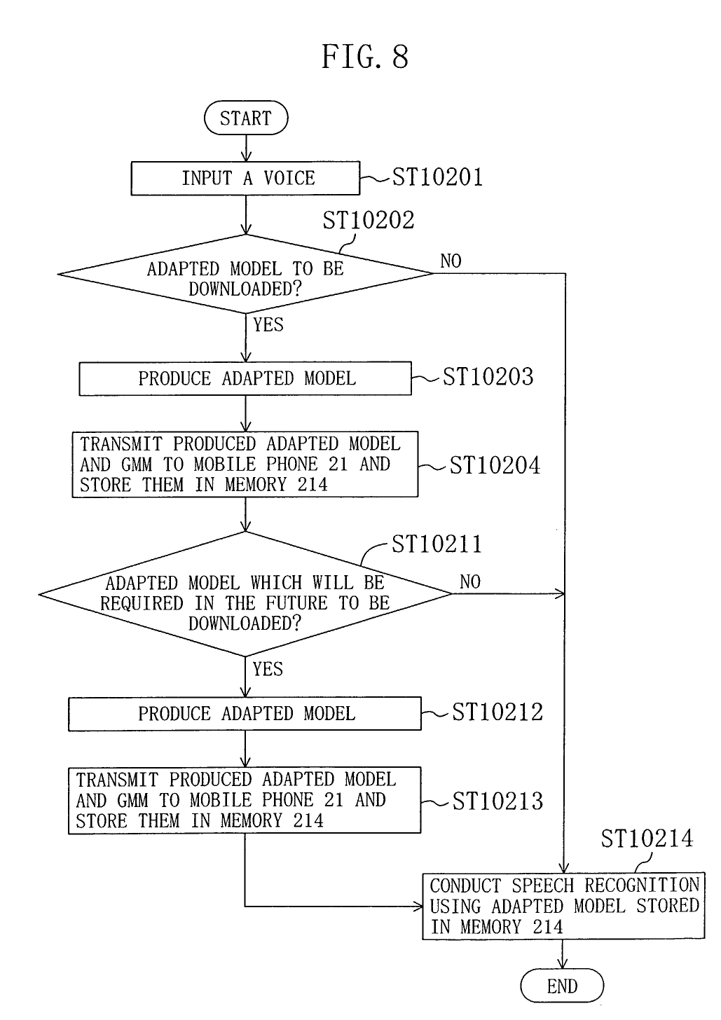

Hereinafter, operation of the speech recognition system having the above structure will be described with reference to FIG. 8. It is herein assumed that the user uses the mobile phone 21 on a train.

[Step ST10201]

The user of the mobile phone 21 inputs voice of the user and ambient noises obtained while the user is not producing the voice independently of each other by using the microphone and speech trigger button 211 mounted to the mobile phone 21. More specifically, the user inputs his/her voice by speaking to the microphone while pressing the speech trigger button. If the speech trigger button is not pressed, ambient noises are input via the microphone. The voice produced by the user while the train stops is input as voice of the user, and noises and voices of people around the user produced while the train is running are input as ambient noises.

[Step ST10202]

The mobile phone 21 prompts the user to determine whether an acoustic model is to be obtained or not. If the user determines that an acoustic model is to be obtained (yes in step ST10202), the data which was input from the data input section 211 in step ST10201 is transmitted from the transmitting section 212 of the mobile phone 21 to the server 22, and the routine proceeds to step ST10203. On the other hand, if the user determines that an acoustic model is not to be obtained (no in step ST10202), no data is transmitted to the server 22, and the routine proceeds to step ST10214.

[Step ST10203]

The receiving section 221 of the server 22 receives the user's voice and the ambient noises from the mobile phone 21.

The adapted-model producing section 223 produces an adapted model adapted to the environment where the mobile phone 21 is used based on at least two of the acoustic models stored in the data storage section 224 and the data received by the receiving section 221.

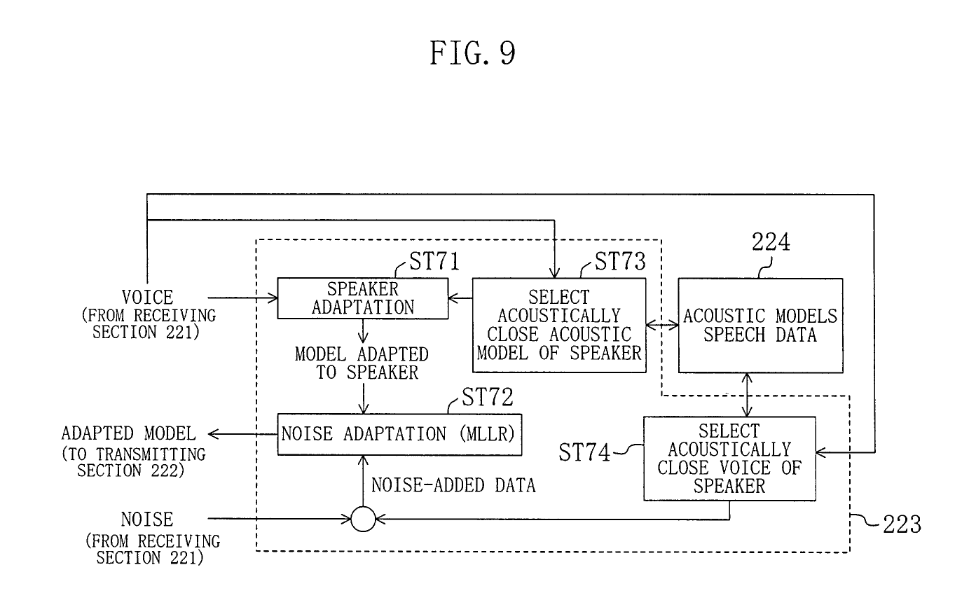

The adapted-model producing section 223 produces an adapted model by using an environmental-noise adaptation algorithm (YAMADA Miichi, BABA Akira, YOSHIZAWA Shinichi, MERA Yuichiro, LEE Akinobu, SARUWATARI Hiroshi and SHIKANO Kiyohiro, “Performance of Environment Adaptation Algorithms in Large Vocabulary Continuous Speech Recognition”, IPSJ SIGNotes, 2000-SLP-35, pp. 31-36, 2001). Hereinafter, how an adapted model is produced using the environmental-noise adaptation algorithm will be described with reference to FIG. 9. A plurality of acoustic models and speech data of a plurality of speakers are stored in advance in the data storage section 124 of the server 22. In the environmental-noise adaptation algorithm, speaker adaptation is conducted based on the voice by using the sufficient statistics and the distance between speakers' characteristics. In the adaptation method using the sufficient statistics and the distance between speakers' characteristics, an acoustic model of a speaker which is acoustically close to the voice of the user is selected from the data storage section 224 (ST73). Thereafter, speaker adaptation is conducted using the selected acoustic model according to the adaptation method using the sufficient statistics and the distance between speakers' characteristics (ST71). In this case, speaker adaptation is conducted using the noise-free voice received from the mobile phone 21. This enables implementation of accurate speaker adaptation. Thereafter, speech data of speakers which are acoustically close to the voice of the user is selected from the data storage section 224 (ST74), and the data of ambient noises received from the mobile phone 21 is added to the selected speech data. Noise-added speech data is thus produced. Noise adaptation is then conducted using the noise-added speech data according to MLLR (step ST72). The adapted model is thus produced.

[Step ST10204]

The adapted model 233 produced by the adapted-model producing section 223 is transmitted from the transmitting section 222 to the receiving section 213 of the mobile phone 21. The adapted model 233 received by the receiving section 213 of the mobile phone 21 is stored in the memory 214. In this example, the newly downloaded acoustic model and GMM are added to the acoustic models and GMMs which have already been stored in the memory 214.

[Step ST10211]

The mobile phone 21 prompts the user to determine whether an adapted model which will be used in the future is to be obtained or not. If the user determines that an adapted model which will be used in the future is to be obtained (yes in step ST10211), the transmitting section 212 of the mobile phone 21 transmits a request signal to the server 22, and the routine proceeds to step ST10212. On the other hand, if the user determines that an adapted model which will be used in the future is not to be obtained (no in step ST10211), the transmitting section 212 does not transmit a request signal, and the routine proceeds to step ST10214.

[Step ST10212]

In response to the request signal from the mobile phone 21, the adapted-model producing section 223 predicts a situation which may be encountered by the user, and produces an acoustic model adapted to the predicted situation. An acoustic model to be produced is selected in the same manner as that described in step ST10112 in FIG. 5, and is produced in the same manner as that described above in step ST10203.

[Step ST10213]

The acoustic model (adapted model) thus produced and a GMM corresponding to the produced model are transmitted from the transmitting section 222 of the server 22 to the mobile phone 21. The receiving section 213 of the mobile phone 21 receives the adapted model and the GMM from the server 22. The adapted model and the GMM received by the receiving section 213 are stored in the memory 214. In this example, the newly downloaded acoustic model and GMM are added to the acoustic models and GMMs which have already been stored in the memory 214.

[Step ST10214]

The speech recognition section 215 conducts speech recognition using an adapted model stored in the memory 214 in the same manner as that described in step ST10114 of FIG. 5.

As has been described above, according to the third embodiment, it is not necessary to store acoustic models corresponding to all situations which may be encountered (but actually, are less likely to be encountered) in the memory 214 of the mobile phone 21. An acoustic model suitable for the encountered situation need only be obtained from the server 22 and stored in the memory 214. This enables reduction in capacity of the memory 214 of the mobile phone 21.

Moreover, the user of the mobile phone 21 can conduct speech recognition using an adapted model adapted to noises around the mobile phone 21, characteristics of the user, tone of the user's voice, and the like. This enables implementation of a high recognition rate.

Moreover, an adapted model can be produced in the server 22 in view of the situation where the mobile phone 21 is used. Accordingly, an acoustic model which is better adapted to the situation where the mobile phone 21 is used can be transmitted to the mobile phone 21.

### Modification

The voice the user and ambient noises obtained while the user is not producing the voice may be automatically distinguished from each other by using speech models and noise models.

Moreover, the acoustic models are not limited to HMMs.

An improved method of the method using the sufficient statistics and the distance between speakers' characteristics (YOSHIZAWA Shinichi, BABA Akira, MATSUNAMI Kanako, MERA Yuichiro, YAMADA Miichi and SHIKANO Kiyohiro, “Unsupervised Traning Based on the Sufficient HMM Statistics from Selected Speakers”, Technical Report of IEICE, SP2000-89, pp. 83-88, 2000) may be used in the adapted-model producing section 223. More specifically, adaptation may be conducted using acoustic models regarding a plurality of speakers and noises and GMMs corresponding to these acoustic models, instead of using acoustic models regarding a plurality of speakers.

The adapted-model producing section 223 may conduct adaptation according to another adaptation method using an acoustic model, such as MAP estimation and an improved method of MLLR.

Uttered text data such as “obtain an acoustic model” may be transmitted to the server 22 as the information 232 of the mobile phone 21.

A feature vector such as cepstrum coefficients resulting from transform of voice may be transmitted to the server 22 as the information 232 of the mobile phone 21.

A stationary terminal such as a television, a personal computer and a car navigation system may be used instead of the mobile phone 21 serving as a terminal device.

The communication path 231 may be a cable (such as a telephone line, an Internet line and a cable television line), a communications network, and a broadcasting network (such as BS/CS digital broadcasting and terrestrial digital broadcasting).

The server and the terminal may be disposed close to each other in a three-dimensional space. For example, the server 22 may be a television or a set-top box, and the mobile phone 21 (terminal) may be a remote controller of the television.

(Fourth Embodiment)

### Structure of the Speech Recognition System

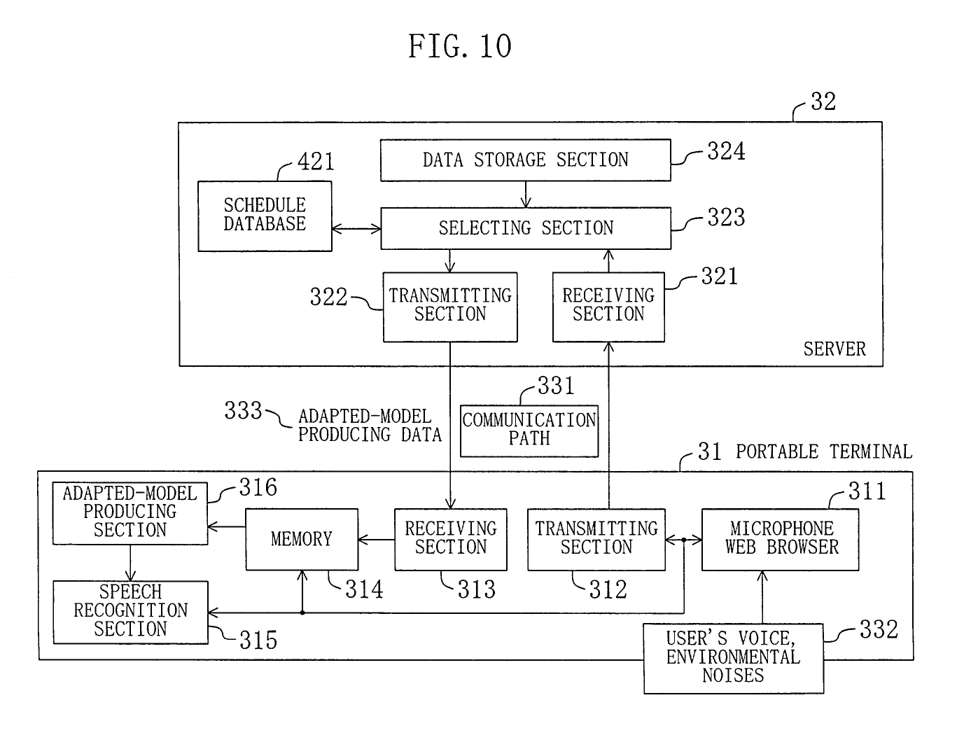

FIG. 10 shows the overall structure of a speech recognition system according to the fourth embodiment. This speech recognition system includes a portable terminal 31 and a server 32. The portable terminal 31 and the server 32 transmit and receive data to and from each other via a communication path 331.

The portable terminal 31 includes a data input section 311, a transmitting section 312, a receiving section 313, a memory 314, an adapted-model producing section 316 and a speech recognition section 315. The data input section 311 inputs information such as a voice of a user of the portable terminal 31 and noises around the portable terminal 31. The data input section 311 includes a microphone and a Web browser. The microphone inputs the user's voice and environmental noises. The Web browser inputs information about the user's voice and the environmental noises. The transmitting section 312 transmits the data which is input by the data input section 311 to the server 32. The receiving section 313 receives adapted-model producing data transmitted from the server 32. The adapted-model producing data received by the receiving section 313 is stored in the memory 314. The adapted-model producing section 316 produces an adapted model using the adapted-model producing data stored in the memory 314. The speech recognition section 315 conducts speech recognition using an adapted model produced by the adapted-model producing section 316. Data of characteristic sounds in various situations (environments) are stored in advance in the memory 314. For example, characteristic sounds at locations such as a supermarket and an exhibition site and characteristic sounds of an automobile, a subway and the like are stored in advance in the memory 314. Such data are downloaded in advance from the server 32 to the memory 314 of the portable terminal 31 before a speech recognition process is conducted by the portable terminal 31.

The server 32 includes a receiving section 321, a transmitting section 322, a selecting section 323, a data storage section 324 and a schedule database 421. A plurality of acoustic models and selection models (GMMs) for selecting the plurality of acoustic models are stored in the data storage section 324. The receiving section 321 receives data transmitted from the portable terminal 31. The selecting section 323 selects from the data storage section 324 adapted-model producing data which is required to conduct adaptation to an environment where the potable terminal 31 is used and the like. The transmitting section 322 transmits the adapted-model producing data selected by the selecting section 323 to the portable terminal 31.

### Operation of the Speech Recognition System

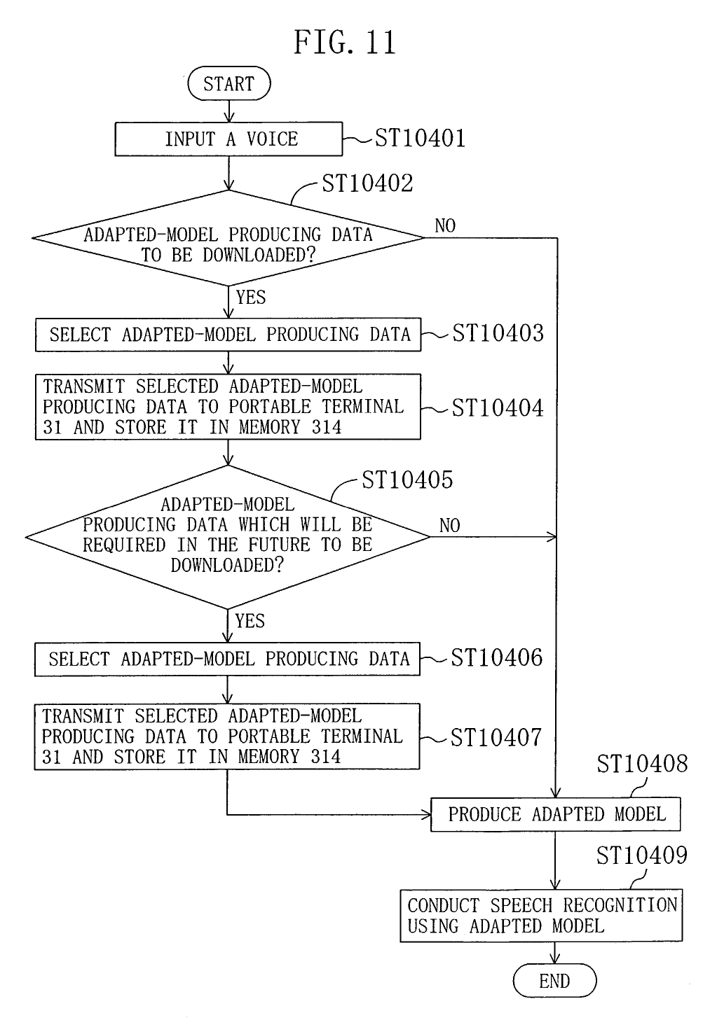

Hereinafter, operation of the speech recognition system having the above structure will be described with reference to FIG. 11. It is herein assumed that the user uses the portable terminal 31 at a supermarket.

[Step ST10401]

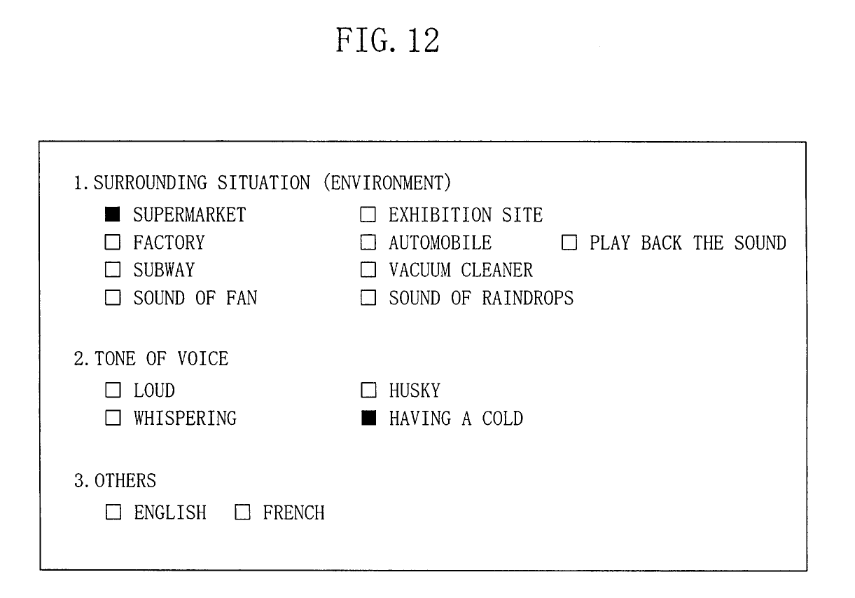

The user of the portable terminal 31 inputs voice such as “what do I make for dinner?” using the microphone of the data input section 311. As shown in FIG. 12, the Web browser of the data input section 311 displays a prompt on a touch panel of the portable terminal 31 to input information such as a surrounding situation (environment) and tone of voice. The user of the portable terminal 31 inputs information such as a surrounding situation (environment) and tone of voice by checking the box of “supermarket” and the box of “having a cold” on the touch panel with a soft pen. If the user of the portable terminal 31 checks the box of “play back the sound”, data of characteristic sounds in the checked situation (environment) are read from the memory 314 and played back. In this case, characteristic sounds at a supermarket are played back.

[Step ST10402]

The portable terminal 31 prompts the user to determine whether adapted-model producing data is to be obtained or not. If the user determines that adapted-model producing data is to be obtained (yes in step ST10402), the information 332 which was input in step ST10401 is transmitted from the transmitting section 312 of the portable terminal 31 to the server 32, and the routine proceeds to step ST10403. On the other hand, if the user determines that adapted-model producing data is not to be obtained (no in step ST10402), no data is transmitted to the server 32, and the routine proceeds to step ST10408.

[Step ST10403]

A plurality of acoustic models and a plurality of GMMs are stored in advance in the data storage section 324 of the server 32 in a one-to-one correspondence, as shown in FIG. 3.

The receiving section 321 of the server 32 receives the information 332 of the portable terminal 31 from the portable terminal 31. Based on the received information 332 of the portable terminal 31, the selecting section 323 selects at least two acoustic models and corresponding GMMs from the acoustic models and the GMMs stored in the data storage section 324. The acoustic models and corresponding GMMs thus selected by the selecting section 323 are “adapted-model producing data”. The selecting section 323 herein selects adapted-model producing data by basically the same method as that of the adapted-model selecting section 123 of the first embodiment. More specifically, the selecting section 323 selects adapted-model producing data based on the voice of the user. In this case, however, acoustic models to be selected are limited by the information which is input via the touch panel out of the information 332 of the portable terminal 31. Note that limitation herein means filtering. For example, if the information “having a cold” and “supermarket” is input via the touch panel, acoustic models and corresponding GMMs are selected by using only GMMs corresponding to the acoustic models relating to “having a cold” and “supermarket”.

[Step ST10404]

The transmitting section 322 transmits the adapted-model producing data 333 selected by the selecting section 323 to the portable terminal 31.

The adapted-model producing data 333 received by the receiving section 313 of the portable terminal 31 is stored in the memory 314. In this example, the newly downloaded adapted-model producing data is added to the adapted-model producing data which have already been stored in the memory 314.

[Step ST10405]

The portable terminal 31 prompts the user to determine whether adapted-model producing data for producing an adapted model which will be used in the future is to be obtained or not. If the user determines that adapted-model producing data is to be obtained (yes in step ST10405), the transmitting section 312 of the portable terminal 31 transmits a request signal to the server 32, and the routine proceeds to step ST10406. On the other hand, if the user determines that adapted-model producing data is not to be obtained (no in step ST10405), the transmitting section 312 of the portable terminal 31 does not transmit a request signal to the server 32 and the routine proceeds to step ST10408.

[Step ST10406]

In response to the request signal from the portable terminal 31, the selecting section 323 predicts a situation which may be encountered by the user, and selects adapted-model producing data for producing an acoustic model adapted to the predicted situation (at least two acoustic models and GMMs corresponding to these models) from the data storage section 324. An acoustic model to be produced is selected in the same manner as that described in step ST10112 in FIG. 5. Adapted-model producing data is selected in the same manner as that described above in step ST10403.

[Step ST10407]

The adapted-model producing data thus selected is transmitted from the transmitting section 322 of the server 32 to the portable terminal 31. The receiving section 313 of the portable terminal 31 receives the adapted-model producing data from the server 32. The adapted-model producing data received by the receiving section 313 is stored in the memory 314. In this example, the newly downloaded adapted-model producing data is added to the adapted-model producing data which have already been stored in the memory 214.

[Step ST10408]

The adapted-model producing section 316 produces an adapted model using the adapted-model producing data which have been stored in the memory 314 so far. In this example, the adapted-model producing section 316 produces an adapted model based on the method using the sufficient statistics and the distance between speakers' characteristics (YOSHIZAWA Shinichi, BABA Akira, MATSUNAMI Kanako, MERA Yuichiro, YAMADA Miichi and SHIKANO Kiyohiro, “Unsupervised Training Based on the Sufficient HMM Statistics from Selected Speakers”, Technical Report of IEICE, SP2000-89, pp. 83-88, 2000). Like the selecting section 323 of the server 32, the adapted-model producing section 316 selects a plurality of acoustic models from the memory 314 based on the voice which was input via the microphone of the data input section 311. The selected acoustic models are a plurality of models which are the best adapted to the user and the ambient noises in the current environment. An adapted model is produced by statistical calculation using the mean, variance, transition probability, and E-M count of the plurality of selected acoustic models (HMMs). The mean, variance and transition probability of HMMs of an adapted model, are the mean and variance of each mixed distribution of each HMM state in the selected acoustic models, and the transition probability in the selected acoustic models. A specific calculation method is given by equations (1) to (3) below. It is herein assumed that the mean and variance of normal distribution in each HMM state of an adapted model are μᵢ^{adp} (i=1, 2, . . . , Nₘᵢₓ) and vᵢ^{adp} (i=1, 2, . . . , Nₘᵢₓ), respectively, where Nₘᵢₓ is the number of mixed distributions. The state transition probability is a^{adp}[i][j] (i, j=1, 2, . . . , Nₛₜₐₜₑ), where Nₛₜₐₜₑ is the number of states. a^{adp}[i][j] is transition probability from state i to state j.

$$\begin{matrix}{μ}_{i}^{adp} = \frac{{\sum }_{j = 1}^{{N}_{sel}} {C}_{mix}^{j} {μ}_{i}^{j}}{{\sum }_{j = 1}^{{N}_{sel}} {C}_{mix}^{j}} ( i = 1 , 2 , … , {N}_{mix} ) & ( 1 ) \\ {v}_{i}^{adp} = \frac{{\sum }_{j = 1}^{{N}_{sel}} {C}_{mix}^{j} ( {v}_{i}^{j} + {( {μ}_{i}^{j} )}^{2} )}{{\sum }_{j = 1}^{{N}_{sel}} {C}_{mix}^{j}} - {( {μ}_{i}^{adp} )}^{2} ( i = 1 , 2 , … , {N}_{mix} ) & ( 2 ) \\ {a}^{adp} [ i ] [ j ] = \frac{{\sum }_{k = 1}^{{N}_{sel}} {C}_{state}^{k} [ i ] [ j ]}{{\sum }_{j = 1}^{{N}_{state}} {\sum }_{k = 1}^{{N}_{sel}} {C}_{state}^{k} [ i ] [ j ]} ( i , j = 1 , 2 , … , {N}_{state} ) & ( 3 )\end{matrix}$$

In the above equations (1) to (3), Nₛₑₗ is the number of selected acoustic models, and μᵢ^{j} (i=1, 2, . . . , Nₘᵢₓ, j=1, 2, . . . , Nₛₑₗ) and vᵢ^{j} (i=1, 2, . . . , Nₘᵢₓ, j=1, 2, . . . , Nₛₑₗ) are the mean and variance of each acoustic model, respectively.

Moreover, C^{j}ₘᵢₓ (j=1, 2, . . . , Nₛₑₗ) and C^{k}ₛₜₐₜₑ[i][j] (k=1, 2, . . . , Nₛₑₗ, i, j=1, 2, . . . , Nₛₜₐₜₑ) are an E-M count (frequency) in the normal distribution and an E-M count relating to state transition, respectively.

[Step ST10409]

The speech recognition section 315 conducts speech recognition using the adapted model produced by the adapted-model producing section 316.

As has been described above, according to the fourth embodiment, it is not necessary to store adapted-model producing data corresponding to all situations which may be encountered (but actually, are less likely to be encountered) in the memory 314 of the portable terminal 31. Adapted-model producing data for adaptation to the encountered situation need only be obtained from the server 32 and stored in the memory 314. This enables reduction in capacity of the memory 314 of the portable terminal 31.

Moreover, the user of the portable terminal 31 can conduct speech recognition using an adapted model adapted to noises around the portable terminal 31, characteristics of the user, tone of the user's voice. This enables implementation of a high recognition rate.

Moreover, adapted-model producing data corresponding to the encountered situation is stored in the memory 314 of the portable terminal 31. Therefore, if the user encounters the same situation, an adapted model can be produced without communicating with the server 32.

### Modification

The adapted-model producing section 316 may be provided within the PDA 11 of FIGS. 1 and 4 and the mobile phone 21 of FIG. 7, and an adapted model may be produced using at least two of acoustic models stored in the memory 114, 214, 314.

Adapted-model producing data of a plurality of users may be stored in the memory 314 in order to produce an adapted model. In this case, an adapted model is produced by selecting the adapted-model producing data of a specific user by inputting the user's voice/designating the user name.

The acoustic models are not limited to HMMs.

A feature vector such as cepstrum coefficients resulting from transform of voice may be transmitted to the server 32 as the information 332 of the portable terminal 31.

Another adaptation method using acoustic models may be used for production of an adapted model for speech recognition.

A microphone different from that of the data input section 311 may be used to input voice used for production of an adapted model for speech recognition.

A stationary terminal such as a television, a personal computer and a car navigation system may be used instead of the portable terminal 31.

The communication path 331 may be a cable (such as a telephone line, an Internet line and a cable television line), a communications network, and a broadcasting network (such as BS/CS digital broadcasting and terrestrial digital broadcasting).

The server and the terminal may be disposed close to each other in a three-dimensional space. For example, the server 32 may be a television or a set-top box, and the portable terminal 31 may be a remote controller of the television.

(Fifth Embodiment)

### Structure of the Speech Recognition System

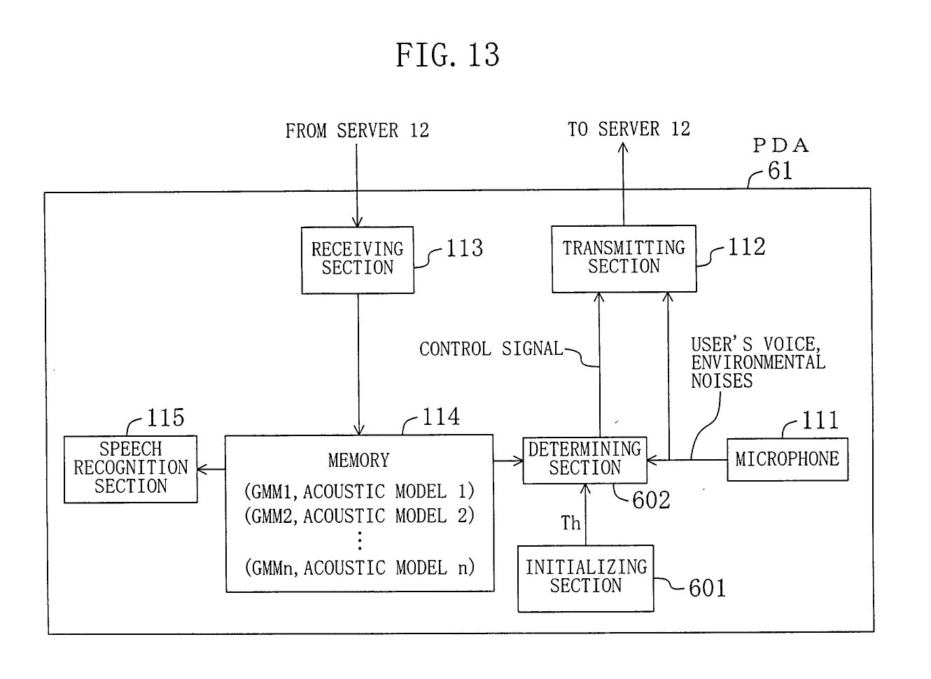

The speech recognition system of the fifth embodiment includes a PDA 61 of FIG. 13 instead of the PDA 11 of FIG. 1. The structure of the speech recognition system of the fifth embodiment is otherwise the same as the speech recognition system of FIG. 1.

The PDA 61 of FIG. 13 includes an initializing section 601 and a determining section 602 in addition to the components of the PDA 11 of FIG. 1. Moreover, n sets of acoustic models and corresponding GMMs which have already been received by the receiving section 113 are stored in the memory 114 (n is a positive integer). The initializing section 601 applies a threshold value Th to the determining section 602. The initializing section 601 may set the threshold value Th automatically or according to an instruction of the user. The determining section 602 transforms the data obtained by the microphone 111, that is, the voice of the user having environmental noises added thereto, into a predetermined feature vector. The determining section 602 then compares the likelihood of the predetermined feature vector and the GMM of each acoustic model stored in the memory 114 with the threshold value Th received from the initializing section 601. If the likelihood of every acoustic model stored in the memory 114 is smaller than the threshold value Th, the determining section 602 applies a control signal to the transmitting section 112. In response to the control signal from the determining section 602, the transmitting section 112 transmits the user's voice and the environmental noises obtained by the microphone 111 to the server 12. On the other hand, if the likelihood of any acoustic model stored in the memory 114 is equal to or higher than the threshold value Th, the determining section 602 does not apply a control signal to the transmitting section 112, and the transmitting section 602 does not transmit any data to the server 12.

### Operation of the Speech Recognition System

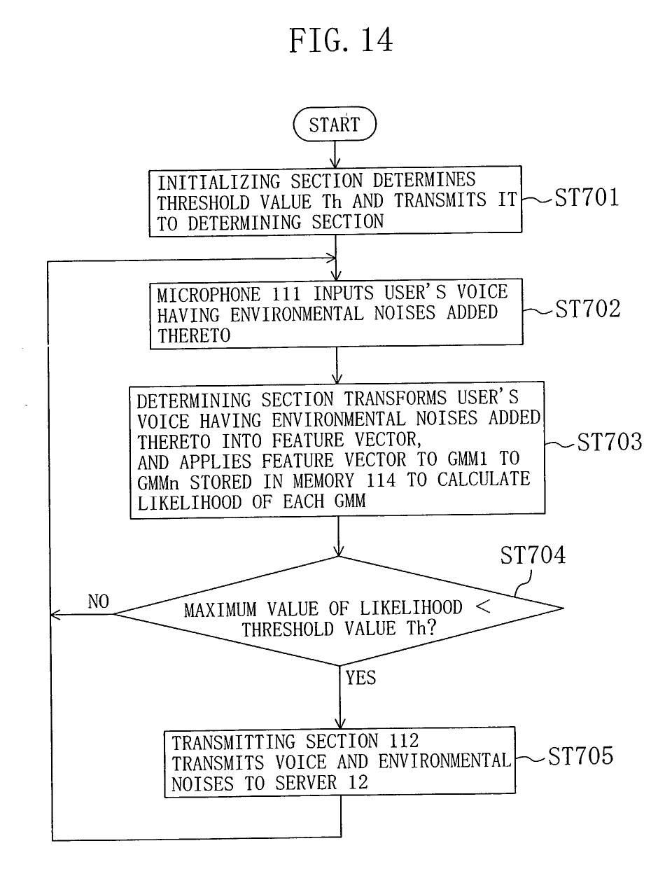

Hereinafter, operation of the speech recognition system having the above structure will be described with reference to FIG. 14.

As described above, n sets of acoustic models and corresponding GMMs which have already been received by the receiving section 113 are stored in the memory 114 of the PDA 61 (where n is a positive integer).

The initializing section 601 of the PDA 61 determines the threshold value Th and transmits the threshold value Th to the determining section 602 (step ST701). The threshold value Th is determined according to an application using speech recognition. For example, if an application relating to security (e.g., an application for processing confidential information by speech recognition, an application for driving an automobile by speech recognition, and the like) is used, the initializing section 601 sets the threshold value Th to a large value. If other applications are used, the initializing section 601 sets the threshold value Th to a small value. When an application to be used is selected, the initializing section 601 applies a threshold value Th corresponding to the selected application to the determining section 602.

The user's voice having environmental noises added thereto is then input via the microphone 111 of the PDA 61 (step ST702).

Thereafter, the user's voice having the environmental noises added thereto thus obtained by the microphone 111 is transformed into a predetermined feature vector by the determining section 602 of the PDA 61. The feature vector thus obtained is applied to the GMM of each acoustic model (i.e., GMM1 to GMMn) stored in the memory 114, whereby the likelihood of each GMM is calculated (step ST703).

The determining section 602 then determines whether the maximum value of the likelihood calculated in step ST703 is smaller than the threshold value Th or not (step ST704).

If the likelihood of every GMM (GMM1 to GMMn) stored in the memory 114 is smaller than the threshold value Th (yes in step ST704), the routine proceeds to step ST705. The determining section 602 then applies a control signal to the transmitting section 112. In response to the control signal from the determining section 602, the transmitting section 112 transmits the user's voice and the environmental noises which were obtained via the microphone 111 to the server 12 (step ST705). The server 12 transmits an acoustic model which is the best adapted to the user's voice and the environmental noises to the PDA 61 in the same manner as that in the first embodiment. This acoustic model is received by the receiving section 113 of the PDA 61 and stored in the memory 114. The speech recognition section 115 then conducts speech recognition using the acoustic model thus stored in the memory 114.

On the other hand, if any likelihood calculated in step ST703 is equal to or higher than the threshold value Th (no in step ST704), the determining section 602 does not apply a control signal to the transmitting section 112. Accordingly, the transmitting section 112 does not transmit any data to the server 12. The speech recognition section 115 then conducts speech recognition using an acoustic model corresponding to the GMM having the highest likelihood calculated in step ST703.

As has been described above, according to the speech recognition system of the fifth embodiment, the user's voice and the environmental noises are transmitted from the PDA 61 to the server 12 only when the likelihood of the user's voice having the environmental noises added thereto and an acoustic model which is stored in advance in the memory 114 of the PDA 61 is smaller than a predetermined threshold value. This enables reduction in transmission and reception of data between the PDA 61 and the server 12.

### Modification

The mobile phone 21 of FIG. 7 and the portable terminal 31 of FIG. 10 may have the initializing section 601 and the determining section 602.

The server and the terminal may be disposed close to each other in a three-dimensional space. For example, the server 12 may be a television or a set-top box, and the PDA 61 (terminal) may be a remote controller of the television.

(Sixth Embodiment)

### Structure of the Speech Recognition System

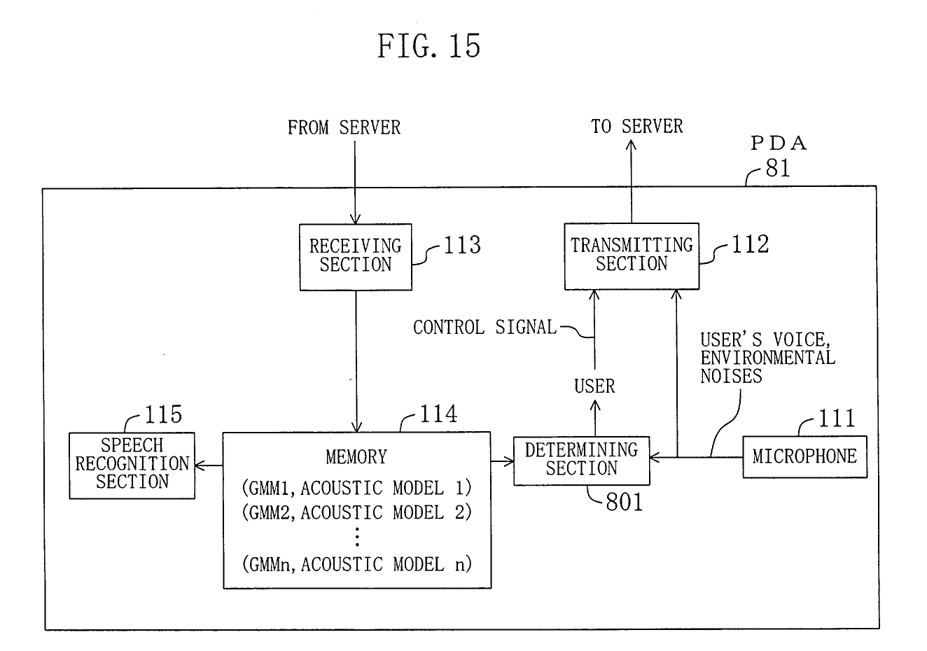

The speech recognition system according to the sixth embodiment includes a PDA 81 of FIG. 15 instead of the PDA 11 of FIG. 1. The structure of the speech recognition system of the sixth embodiment is otherwise the same as the speech recognition system of FIG. 1.

The PDA 81 of FIG. 15 includes a determining section 801 in addition to the components of the PDA 11 of FIG. 1. Moreover, n sets of acoustic models and corresponding GMMs which have already been received by the receiving section 113 are stored in the memory 114 (n is a positive integer). The determining section 801 transforms the data obtained by the microphone 111, that is, the voice of the user having environmental noises added thereto, into a predetermined feature vector. The determining section 801 then compares the likelihood of the predetermined feature vector and the GMM of each acoustic model stored in the memory 114 with a predetermined threshold value. If the likelihood of every acoustic model stored in the memory 114 is smaller than the threshold value, the determining section 801 prompts the user to determine whether an acoustic model is to be downloaded or not. If the user determines that an acoustic model is to be downloaded, the transmitting section 112 transmits the user's voice and the environmental noises obtained by the microphone 111 to the server 12. On the other hand, if the user determines that an acoustic model is not to be downloaded, the transmitting section 112 does not transmit any data to the server 12. Moreover, if the likelihood of any acoustic model stored in the memory 114 is equal to or higher than the threshold value, the transmitting section 112 does not transmit any data to the server 12.

### Operation of the Speech Recognition System

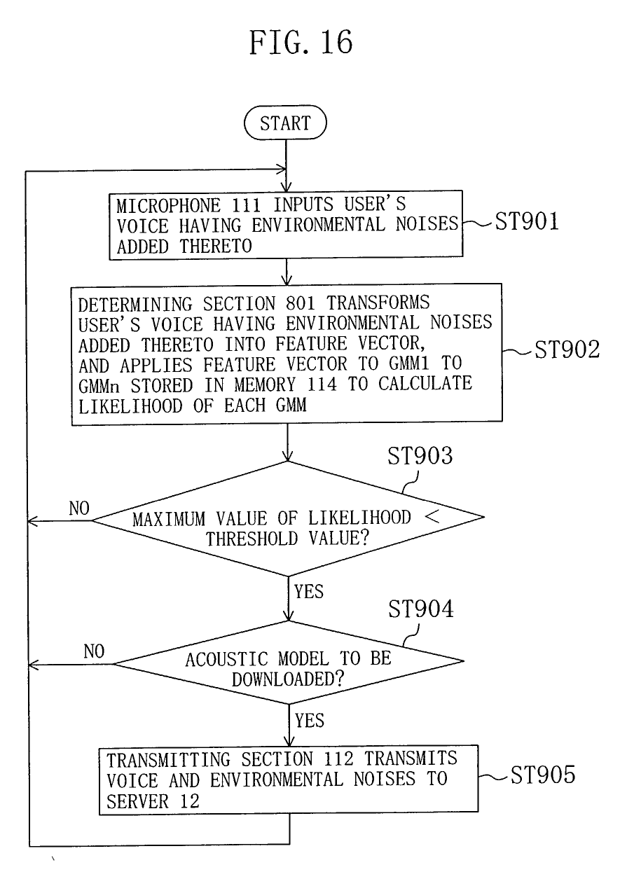

Hereinafter, operation of the speech recognition system having the above structure will be described with reference to FIG. 16.

As described above, n sets of acoustic models and corresponding GMMs which have already been received by the receiving section 113 are stored in the memory 114 of the PDA 81 (where n is a positive integer).

The user's voice having environmental noises added thereto is then input via the microphone 111 of the PDA 81 (step ST901).

Thereafter, the user's voice having the environmental noises added thereto thus obtained by the microphone 111 is transformed into a predetermined feature vector by the determining section 801 of the PDA 81. The feature vector thus obtained is applied to the GMM of each acoustic model (i.e., GMM1 to GMMn) stored in the memory 114, whereby the likelihood of each GMM is calculated (step ST902).

The determining section 801 then determines whether the maximum value of the likelihood calculated in step ST902 is smaller than a predetermined threshold value or not (step ST903).

If the likelihood of every GMM (GMM1 to GMMn) stored in the memory 114 is smaller than the threshold value (yes in step ST903), the routine proceeds to step ST904. The determining section 801 then prompts the user to determine whether an acoustic model is to be downloaded or not (step ST904). If the user determines that an acoustic model is to be downloaded (yes in step ST904), the transmitting section 112 transmits the user's voice and the environmental noises which were obtained by the microphone 111 to the server 12 (step ST905). The server 12 transmits an acoustic model which is the best adapted to the user's voice and the environmental noises to the PDA 81 in the same manner as that of the first embodiment. This acoustic model is received by the receiving section 113 of the PDA 81 and stored in the memory 114. The speech recognition section 115 conducts speech recognition using the acoustic model thus stored in the memory 114.

On the other hand, if any likelihood calculated in step ST902 is equal to or higher than the threshold value (no in step ST903) and if the user determines that an acoustic model is not to be downloaded (no in step ST904), the transmitting section 112 does not transmit any data to the server 12. The speech recognition section 115 then conducts speech recognition using an acoustic model of the GMM having the highest likelihood calculated in step ST902.

As has been described above, according to the speech recognition system of the sixth embodiment, the user's voice and the environmental noises are transmitted from the PDA 81 to the server 12 only when the likelihood of the user's voice having the environmental noises added thereto and an acoustic model which is stored in advance in the memory 114 of the PDA 81 is smaller than a predetermined threshold value and the user determines that an acoustic model is to be downloaded. This enables reduction in transmission and reception of data between the PDA 81 and the server 12.

### Modification

The mobile phone 21 of FIG. 7 and the portable terminal 31 of FIG. 10 may have the determining section 801.

The server and the terminal may be disposed close to each other in a three-dimensional space. For example, the server 12 may be a television or a set-top box, and the PDA 81 (terminal) may be a remote controller of the television.

(Seventh Embodiment)

### Structure of the Speech Recognition System

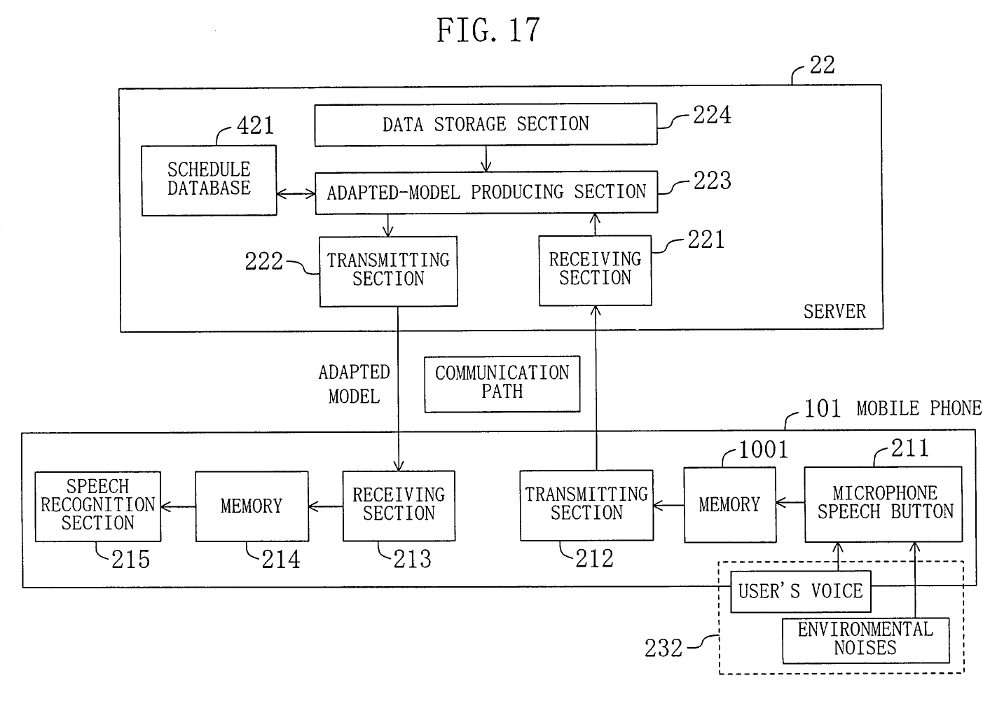

FIG. 17 shows the structure of a speech recognition system according to the seventh embodiment. This speech recognition system includes a mobile phone 101 instead of the mobile phone 21 of FIG. 7. The structure of the speech recognition system of the seventh embodiment is otherwise the same as the speech recognition system of FIG. 7.

The mobile phone 101 of FIG. 17 includes a memory 1001 in addition to the components of the mobile phone 21 of FIG. 7. The voice of a user and environmental noises are input by the data input section 211 and stored in the memory 1001. The transmitting section 212 transmits the user's voice and the environmental noises stored in the memory 1001 to the server 22.

### Operation of Speech Recognition System

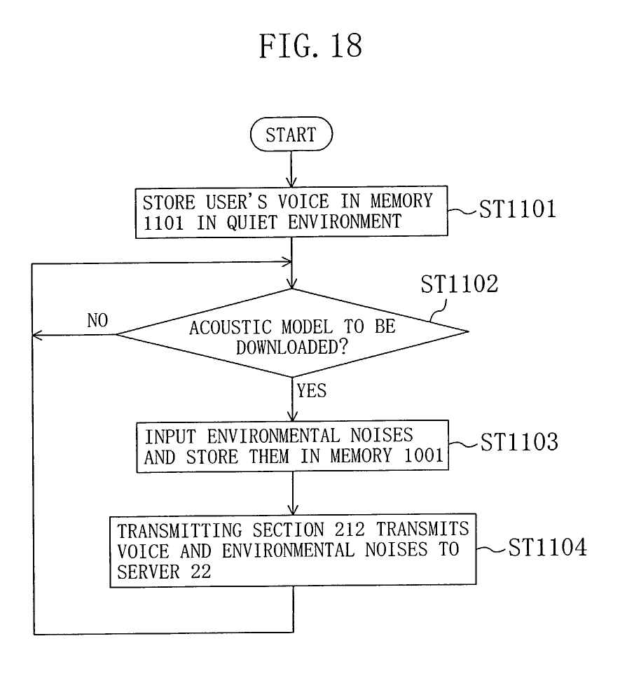

Hereinafter, operation of the speech recognition system having the above structure will be described with reference to FIG. 18.

In the case where an adapted model is produced using a voice of a user in a quiet environment, an adapted model can be produced with higher accuracy as compared to the case where an adapted model is produced using a noise-added voice. In the case where the user carries the mobile phone 101, there are noises (such as noises of automobiles, speaking voices of the people around the user, the sound of fans in the office) in most of the day. However, ambient noises may hardly exist in a certain period of time (e.g., while the user has a break at a park or the like). At this timing, the user of the mobile phone 101 speaks while pressing the speech trigger button. The voice of the user in a quiet environment is thus stored in the memory 1001 (step ST1101).

If the user attempts to use a speech recognition function, the mobile phone 101 prompts the user to determine whether an acoustic model is to be downloaded or not (step ST1102). If the user determined that an acoustic model is to be downloaded (yes in step ST1102), the user inputs environmental noises using the microphone without pressing the speech trigger button. The environmental noises thus input by the microphone are stored in the memory 1001 (step ST1103).

The transmitting section 212 then transmits the user's voice and the environmental noises which are stored in the memory 1001 to the server 22 (step ST1104). The server 22 transmits an acoustic model which is the best adapted to the user's voice and the environmental noises to the mobile phone 101 in the same manner as that of the third embodiment. This acoustic model is received by the receiving section 213 of the mobile phone 101 and stored in the memory 214. The speech recognition section 215 conducts speech recognition using this acoustic model stored in the memory 214.

According to the speech recognition system of the seventh embodiment, the mobile phone 101 has the memory 1001. Therefore, speaker adaptation can be conducted using the voice of the user in a less-noisy environment. This enables implementation of accurate speaker adaptation.

Moreover, once the user's voice is stored, the user need no longer speak every time an adapted model is produced. This reduces the burden on the user.

### Modification

Voices of a plurality of people in a quiet environment may be stored in the memory 1001. In this case, the voices of the plurality of people in a quiet environment and their names are stored in the memory 1001 in a one-to-one correspondence. If an adapted model is to be obtained, an adapted model is produced by determining the voice of the user by designating the user name. This enables a highly accurate adapted model to be used even in an equipment which is used by a plurality of people such as a remote controller of a television.

In the above example, the user's voice and the environmental noises which are stored in the memory 1001 are transmitted to the server 22 in step ST1104. However, the user's voice in a quiet environment with environmental noises added thereto, which is stored in the memory 1001, may be transmitted to the server 22.

The server and the terminal may be disposed close to each other in a three-dimensional space. For example, the server 22 may be a television or a set-top box, and the mobile phone 101 (terminal) may be a remote controller of the television.

What is claimed is:

1. A terminal device, comprising:
a transmitting means for transmitting a voice produced by a user and environmental noises to a server device;
a receiving means for receiving from the server device an acoustic model adapted to the voice of the user and the environmental noises;
a first storage means for storing the acoustic model received by the receiving means; and
a speech recognition means for conducting speech recognition using the acoustic model stored in the first storage means.

2. The terminal device according to claim 1, wherein the receiving means further receives an acoustic model which will be used by the user in future from the server device.

3. The terminal device according to claim 1, further comprising:
a determining means for comparing similarity between the voice of the user having the environmental noises added thereto and an acoustic model which has already been stored in the first storage means with a predetermined threshold value, wherein
if the similarity is smaller than the threshold value, the transmitting means transmits the voice of the user and the environmental noises to the server device.

4. The terminal device according to claim 3, wherein
if the similarity is smaller than the threshold value, the determining means prompts the user to determine whether an acoustic model is to be obtained or not, and
if the user determines that an acoustic model is to be obtained, the transmitting means transmits the voice of the user and the environmental noises to the server device.

5. The terminal device according to claim 1, further comprising:
a second storage means for storing a voice produced by a user, wherein
if environmental noises are obtained, the transmitting means transmits the environmental noises and the voice of the user stored in the second storage means to the server device.

6. The terminal device according to claim 1, wherein the terminal device prompts the user to select a desired environment from various environments, and plays back a characteristic sound of the selected environment.

7. A terminal device, comprising:
a transmitting means for transmitting a voice produced by a user and environmental noises to a server device;
a receiving means for receiving from the server device acoustic-model producing data for producing an acoustic model adapted to the voice of the user and the environmental noises;
a first storage means for storing the acoustic-model producing data received by the receiving means;
a producing means for producing the acoustic model adapted to the voice of the user and the environmental noises by using the acoustic-model producing data stored in the first storage means; and
a speech recognition means for conducting speech recognition using the acoustic model produced by the producing means.

8. The terminal device according to claim 7, wherein the receiving means further receives acoustic-model producing data which will be used by the user in future from the server device.

9. The terminal device according to claim 7, wherein the terminal device prompts the user to select a desired environment from various environments, and plays back a characteristic sound of the selected environment.

10. A server device, comprising:
a storage means for storing a plurality of acoustic models each adapted to a corresponding speaker and a corresponding environment;
a receiving means for receiving from a terminal device a voice produced by a user and environmental noises;
a selecting means for selecting from the storage means an acoustic model which is adapted to the voice of the user and the environmental noises received by the receiving means; and
a transmitting means for transmitting the acoustic model selected by the selecting means to the terminal device.

11. The server device according to claim 10, wherein the selecting means selects an acoustic model which will be used by a user of the terminal device in future from the storage means.

12. The server device according to claim 10, wherein each of the plurality of acoustic models stored in the storage means is adapted also to a tone of voice of a corresponding speaker.

13. The server device according to claim 10, wherein each of the plurality of acoustic models stored in the storage means is adapted also to characteristics of an inputting means for obtaining a voice produced by a speaker in order to produce the acoustic model.

14. A server device, comprising:
a storage means for storing a plurality of acoustic models each adapted to a corresponding speaker and a corresponding environment;
a receiving means for receiving from a terminal device a voice produced by a user and environmental noises;
a producing means for producing an acoustic model adapted to the voice of the user and the environmental noises, based on the voice of the user and the environmental noises received by the receiving means and the plurality of acoustic models stored in the storage means; and
a transmitting means for transmitting the acoustic model produced by the producing means to the terminal device.

15. The server device according to claim 14, wherein the producing means produces an acoustic model which will be used by a user of the terminal device in future.

16. The server device according to claim 14, wherein each of the plurality of acoustic models stored in the storage means is adapted also to a tone of voice of a corresponding speaker.

17. The server device according to claim 14, wherein each of the plurality of acoustic models stored in the storage means is adapted also to characteristics of an inputting means for obtaining a voice produced by a speaker in order to produce the acoustic model.

18. A server device, comprising:
a storage means for storing a plurality of acoustic models each adapted to a corresponding speaker and a corresponding environment;
a receiving means for receiving from a terminal device a voice produced by a user and environmental noises;
a selecting means for selecting from the storage means acoustic-model producing data for producing an acoustic model which is adapted to the voice of the user and the environmental noises received by the receiving means; and
a transmitting means for transmitting the acoustic-model producing data selected by the selecting means to the terminal device.

19. The server device according to claim 18, wherein the selecting means selects acoustic-model producing data which will be used by a user of the terminal device in future from the storage means.

20. The server device according to claim 18, wherein each of the plurality of acoustic models stored in the storage means is adapted also to a tone of voice of a corresponding speaker.

21. The server device according to claim 18, wherein each of the plurality of acoustic models stored in the storage means is adapted also to characteristics of an inputting means for obtaining a voice produced by a speaker in order to produce the acoustic model.

22. A speech recognition method, comprising the steps of:
preparing a plurality of acoustic models each adapted to a corresponding speaker, a corresponding environment, and a corresponding tone of voice;
obtaining an acoustic model adapted to a voice produced by a user and environmental noises, based on the voice of the user, the environmental noises and the plurality of acoustic models; and
conducting speech recognition using the obtained acoustic model.

23. The speech recognition method according to claim 22, wherein each of the plurality of acoustic models is adapted also to characteristics of an inputting means for obtaining a voice produced by a speaker in order to produce the acoustic model.
